(19) United States
(12) Patent Application Publication
(10) Pub. No.: US 2009/0222266 A1
(43) Pub. Date: Sep. 3, 2009

(54) APPARATUS, METHOD, AND RECORDING MEDIUM FOR CLUSTERING PHONEME MODELS

(75) Inventor: Masaru Sakai, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/393,748

(22) Filed: Feb. 26, 2009

(30) Foreign Application Priority Data
Feb. 29, 2008 (JP) 2008-049207

(51) Int. Cl. G10L 15/04

(52) U.S. Cl. 704/254; 704/E15.004

(57) ABSTRACT

A phoneme model clustering apparatus stores a classification condition of a phoneme context, generates a cluster by performing a clustering of context-dependent phoneme models having different acoustic characteristics of central phoneme for each model having a common central phoneme according to the classification condition, sets a conditional response for each cluster according to acoustic characteristics of context-dependent phoneme models included in the cluster, generates a set of clusters by performing a clustering on clusters according to the conditional response, and outputs the context-dependent phoneme models included in the set of clusters.

### CROSS-REFERENCE TO RELATED APPLICATIONS

This application is based upon and claims the benefit of priority from Japanese Patent Application No. 2008-049207, filed on Feb. 29, 2008; the entire contents of which are incorporated herein by reference.

### BACKGROUND OF THE INVENTION

1. Field of the Invention

The present invention relates to an apparatus, a method, and a computer-readable recording medium for clustering context-dependent phoneme models.

2. Description of the Related Art

Conventionally, in the field of speech recognition, a method in which an acoustic characteristic of input speech is expressed by a probability model with a phoneme being designated as a unit is used. Such a probability model is generated by performing training using speech data obtained by pronouncing corresponding phonemes.

It is known that an acoustic characteristic of a certain phoneme is such that it is largely affected by a class of a phoneme adjacent to the phoneme (phoneme context). Therefore, when a certain phoneme is modeled, a plurality of probability models different for each phoneme context is frequently generated by using a phoneme unit, taking the phoneme context into consideration. Such a phoneme model is referred to as the context-dependent phoneme model.

By using the context-dependent phoneme model, a change of the acoustic characteristic of a central phoneme by the phoneme context can be modeled in detail.

However, when the context-dependent phoneme model is used, the total number of phonemes taking the phoneme context into consideration, that is, the total number of context-into consideration, that is, the total number of context-dependent phoneme models to be trained considerably increases, thereby causing a problem in that speech data for training an individual context-dependent phoneme model becomes insufficient or absent.

As a solution to this problem, the speech data for training needs only to be shared among the context-dependent phoneme models similar to each other. To realize this, however, clustering needs to be performed for each context-dependent phoneme model that can share the speech data.

As a method of clustering the context-dependent phoneme models, there are methods disclosed in JP-A 2001-100779 (KOKAI) and in S. J. Young, J. J. Odell, P. C. Woodland, “Tree-Based State Tying for High Accuracy Acoustic Modeling”, Proceedings of the workshop on Human Language Technology, pp. 307-312, 1994. According to techniques described in these documents, clustering is executed with respect to a set of context-dependent phoneme models having a common central phoneme, based on a difference of the phoneme context or the like.

Thus, because clustering of the context-dependent phoneme models can be performed by using the techniques disclosed in these documents, speech data for training can be shared among the context-dependent phoneme models. Accordingly, it can be prevented that the speech data for training the context-dependent phoneme model becomes insufficient or absent.

However, in the techniques described in the above documents, because clustering is performed for each context-dependent phoneme model having the common central phoneme, speech data for training cannot be shared among the context-dependent phoneme models having a central phoneme different from each other.

On the other hand, in Frank Diehl, Asuncion Moreno, and Enric Monte, “CROSSLINGUAL ACOUSTIC MODELING DEVELOPMENT FOR AUTOMATIC SPEECH RECOGNITION”, Proceedings of ASRU, pp. 425-430, 2007, there is proposed a technique for performing decision tree clustering, with all context-dependent phoneme models having a central phoneme different from each other being set as targets. According to this technique, clustering can be executed among all context-dependent phoneme models, regardless of whether the central phoneme is different.

Accordingly, even in the case of context-dependent phoneme models having a different central phoneme, when these are similar to each other, these can be classified in the same class. Therefore, efficient clustering can be expected.

However, in the technique described in “CROSSLINGUAL ACOUSTIC MODELING DEVELOPMENT FOR AUTOMATIC SPEECH RECOGNITION”, clustering is performed among all the context-dependent phoneme models, regardless of whether the central phoneme is different. Therefore, optimum clustering is not performed among the context-dependent phoneme models having the common central phoneme. In this case, efficient sharing of the data for training becomes difficult.

That is, according to the techniques described in JP-A 2001-100779 (KOKAI) and “Tree-Based State Tying for High Accuracy Acoustic Modeling”, an optimum clustering result can be obtained among the context-dependent phoneme models having the common central phoneme; however, the speech data for training cannot be shared among the context-dependent phoneme models having a central phoneme different from each other. On the other hand, according to the technique described in “CROSSLINGUAL ACOUSTIC MODELING DEVELOPMENT FOR AUTOMATIC SPEECH RECOGNITION”, the speech data for training can be shared among the context-dependent phoneme models having a central phoneme different from each other by performing clustering with respect to the context-dependent phoneme models having a different central phoneme as a target. However, efficient sharing of the speech data for training becomes difficult, because an optimum clustering result is not always obtained with respect to the context-dependent phoneme models having the common central phoneme.

### SUMMARY OF THE INVENTION

According to one aspect of the present invention, there is provided an apparatus for clustering phoneme models. The apparatus includes an input unit configured to input a plurality of context-dependent phoneme models each including a phoneme context indicating a class of an adjacent phoneme and indicating a phoneme model having different acoustic characteristic of a central phoneme according to the phoneme context; a first storage unit configured to store therein a classification condition of the phoneme context set according to the acoustic characteristic; a first clustering unit configured to generate a cluster including the context-dependent phoneme models having a common central phoneme and common acoustic characteristic by performing a clustering for each of the context-dependent phoneme models having a common central phoneme according to the classification condition; a first setting unit configured to set a conditional response indicating a response to each classification condition according to the acoustic characteristic with respect to each cluster according to the acoustic characteristic of the context-dependent phoneme model included in the cluster.

Furthermore, according to another aspect of the present invention, there is provided a method of clustering phoneme models for a phoneme model clustering apparatus including a first storage unit configured to store therein a classification condition of a phoneme context set according to acoustic characteristic. The method includes inputting a plurality of context-dependent phoneme models each including the phoneme context and indicating a phoneme model having different acoustic characteristic of a central phoneme according to the phoneme context; first clustering including performing a clustering for each of the context-dependent phoneme models having a common central phoneme according to the classification condition, and generating a cluster including the context-dependent phoneme models having a common central phoneme and common acoustic characteristic; setting including setting a conditional response indicating a response to each classification condition according to the acoustic characteristic with respect to each cluster according to the acoustic characteristic of the context-dependent phoneme model included in the cluster; second clustering including performing a clustering with respect to a plurality of clusters according to the conditional response corresponding to the classification condition, and generating a set of clusters; and outputting the context-dependent phoneme models included in the set of clusters.

Moreover, according to still another aspect of the present invention, there is provided a computer-readable recording medium configured to store therein a computer program for clustering phoneme models for a phoneme model clustering apparatus including a first storage unit configured to store therein a classification condition of a phoneme context set according -to acoustic characteristic. The computer program when executed causes a computer to execute inputting a plurality of context-dependent phoneme models each including the phoneme context and indicating a phoneme model having different acoustic characteristic of a central phoneme according to the phoneme context; first clustering including performing a clustering for each of the context-dependent phoneme models having a common central phoneme according to the classification condition, and generating a cluster including the context-dependent phoneme models having a common central phoneme and common acoustic characteristic; setting including setting a conditional response indicating a response to each classification condition according to the acoustic characteristic with respect to each cluster according to the acoustic characteristic of the context-dependent phoneme model included in the cluster; second clustering including performing a clustering with respect to a plurality of clusters according to the conditional response corresponding to the classification condition, and generating a set of clusters; and outputting the context-dependent phoneme models included in the set of clusters.

### BRIEF DESCRIPTION OF THE DRAWINGS

FIG. 1 is a block diagram of a configuration of a phoneme model clustering apparatus according to a first embodiment of the present invention;

FIG. 2 is an exemplary set of context-dependent phoneme models used in the first embodiment;

FIG. 3 is a table structure of a phoneme-model classification-condition storage unit according to the first embodiment;

FIG. 4 is a schematic diagram for explaining an HMM in the first embodiment used as a context-dependent phoneme model;

FIG. 5 depicts an outline of first decision tree clustering executed by a first clustering unit according to the first embodiment;

FIG. 6 is an exemplary HMM respectively corresponding to the set of context-dependent phoneme models;

FIG. 7 is a schematic diagram for explaining a state common to the HMM included in the same cluster in clustering performed by the first clustering unit;

FIG. 8 is a schematic diagram for explaining a state of the HMM when speech data for training is shared based on a clustering result obtained by the first clustering unit;

FIG. 9 is a schematic diagram for explaining a virtual context-dependent phoneme model defined with respect to the set of context-dependent phoneme models in a virtual-phoneme-model defining unit according to the first embodiment;

FIG. 10 is a schematic diagram for explaining a virtual phoneme context and the set of the phoneme contexts defined as the virtual phoneme context;

FIG. 11 is an exemplary common response to the virtual phoneme contexts set based of each conditional response of the set of the phoneme context by a virtual-model conditional-response setting unit;

FIG. 12 depicts a table structure of a virtual-phoneme-model classification-condition storage unit according to the first embodiment;

FIG. 13 depicts a table structure of a central-phoneme-class classification-condition storage unit according to the first embodiment;

FIG. 14 depicts an outline of second decision tree clustering executed by a second clustering unit according to the first embodiment;

FIG. 15 is an exemplary clustering result output by an output unit according to the first embodiment;

FIG. 16 depicts an outline of decision tree clustering generated by clustering according to a conventional technique;

FIG. 17 is a schematic diagram for explaining a state common to the HMM included in the same cluster in the clustering performed by the second clustering unit;

FIG. 18 is a schematic diagram for explaining a state of the HMM when the speech data for training is shared based on a clustering result obtained by the second clustering unit;

FIG. 19 is a flowchart of a clustering process procedure performed by the phoneme model clustering apparatus;

FIG. 20 is a flowchart of a setting procedure of the conditional response corresponding to each classification condition in the virtual-phoneme-model conditional-response setting unit;

FIG. 21 is a block diagram of a configuration of a phoneme model clustering apparatus according to a second embodiment of the present invention;

FIG. 22 depicts a table structure of a virtual-phoneme-model classification-condition storage unit according to the second embodiment;

FIG. 23 is a flowchart of a setting procedure of a conditional response corresponding to each classification condition in a virtual-phoneme-model conditional-response setting unit according to the second embodiment;

FIG. 24 is a block diagram of a configuration of a phoneme model clustering apparatus according to a third embodiment of the present invention;

FIG. 25 depicts a table structure of a virtual-phoneme-model classification-condition storage unit according to the third embodiment;

FIG. 26 is a flowchart of a setting procedure of a conditional response corresponding to each classification condition in a virtual-phoneme-model conditional-response setting unit according to the third embodiment;

FIG. 27 is a block diagram of a configuration of a phoneme model clustering apparatus according to a fourth embodiment of the present invention;

FIG. 28 depicts a history of a common response of a respective virtual phoneme contexts set by a virtual-phoneme-model conditional-response setting unit according to the fourth embodiment;

FIG. 29 is a flowchart of a setting procedure of a conditional response corresponding to each classification condition in the virtual-phoneme-model conditional-response setting unit according to the fourth embodiment; and

FIG. 30 depicts a hardware configuration in the phoneme model clustering apparatus.

### DETAILED DESCRIPTION OF THE INVENTION

Exemplary embodiments of the present invention will be explained in detail below with reference to the accompanying drawings.

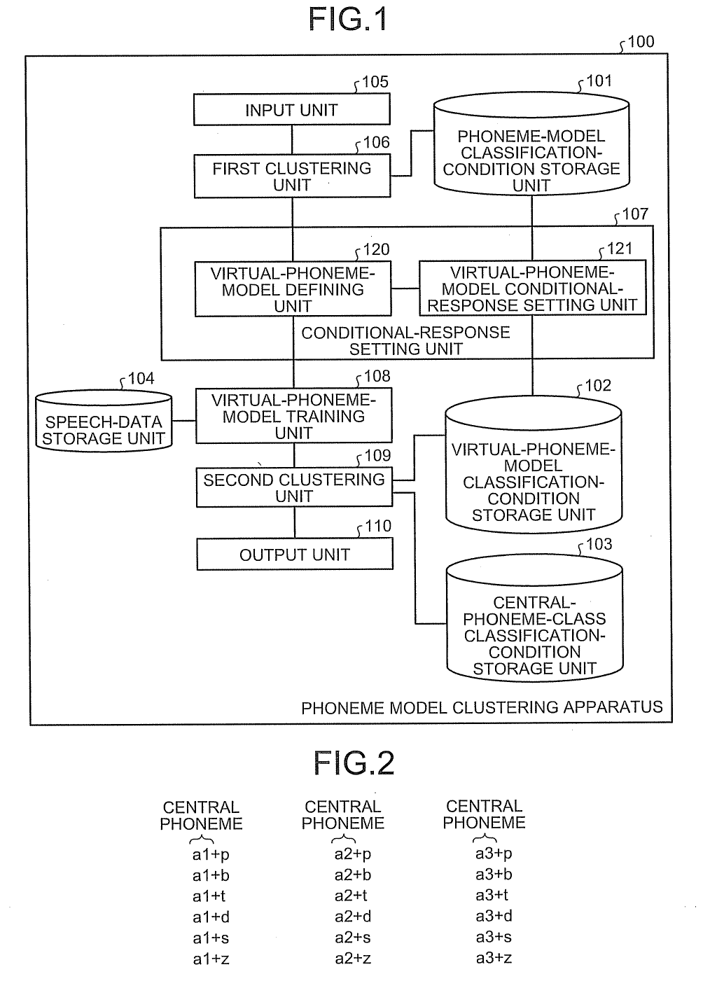

As shown in FIG. 1, a phoneme model clustering apparatus 100 according to a first embodiment of the present invention includes a phoneme-model classification-condition storage unit 101, a virtual-phoneme-model classification-condition storage unit 102, a central-phoneme-class classification-condition storage unit 103, a speech-data storage unit 104, an input unit 105, a first clustering unit 106, a conditional-response setting unit 107, a virtual-phoneme-model training unit 108, a second clustering unit 109, and an output unit 110.

The phoneme model clustering apparatus 100 performs clustering based on a phoneme context and a central phoneme class with respect to a set including at least two context-dependent phoneme models having a central phoneme different from each other.

The central phoneme indicates a phoneme as a center of the phonemes included in a phoneme model, which can be any of a vowel or consonant. The phoneme context indicates a class of the phoneme adjacent to the central phoneme. The context-dependent phoneme model is a phoneme model modeled, taking into consideration an acoustic characteristic of the central phoneme, which changes according to the phoneme context.

An exemplary context-dependent phoneme model used in the first embodiment is explained. In FIG. 2, “a*+*” indicates one context-dependent phoneme model. In the context-dependent phoneme model according to the first embodiment, the central phonemes are set as “a1”, “a2”, and “a3”, and the phoneme contexts are set as “*+p”, “*+b”, “*+t”, “*+d”, “*+s”, and “*+z”.

In a context dependent model “a1+p” shown in FIG. 2, the central phoneme is phoneme “a1” and a right phoneme context that follows the central phoneme is phoneme “p”. For other context-dependent phoneme models, it is assumed that the right phoneme context follows the central phoneme.

In the first embodiment, a set of context-dependent phoneme models added with only the right phoneme context is mentioned as the set of context-dependent phoneme models to be clustered by the phoneme model clustering apparatus 100. However, in the first embodiment, a clustering target is not limited to the set of context-dependent phoneme models added with only the right phoneme context. For example, a set of context-dependent phoneme models added with only a left phoneme context (e.g., “p−a1”), a set of context-dependent phoneme models added with both the left phoneme context and the right phoneme context (e.g., “p−a1+b”), and a set combining these sets can be set as the clustering target.

In the phoneme model clustering apparatus 100, the context-dependent phoneme model to be clustered is not limited to the phoneme model added with only one phoneme context preceding or following a certain central phoneme, and the phoneme model clustering apparatus 100 can execute clustering with respect to the context-dependent phoneme model added with any one or more of at least one of the preceding left phoneme contexts and at least one of the following right phoneme contexts.

Thus, an arbitrary context-dependent phoneme model can be used for the context-dependent phoneme model to be clustered in the phoneme model clustering apparatus 100. In the first embodiment, a case that the set of context-dependent phoneme models added with only the right phoneme context is processed is explained. However, because extension to clustering of arbitrary context-dependent phoneme models can be easily carried out by person skilled in the art based on this explanation, explanations of other context-dependent phoneme models will be omitted.

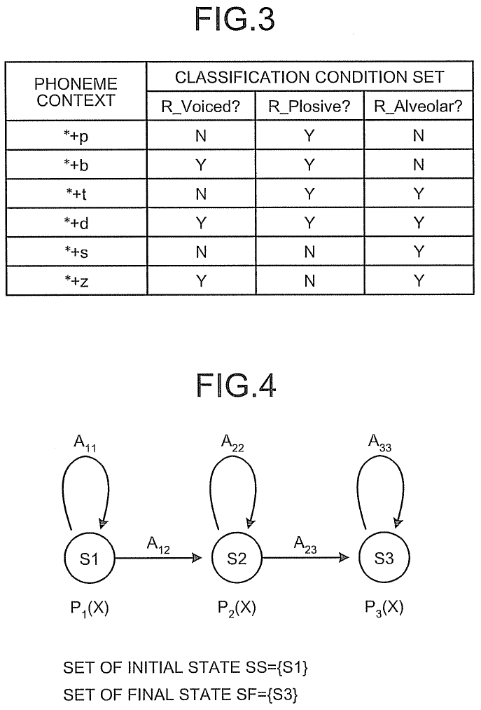

The phoneme-model classification-condition storage unit 101 stores the respective phoneme contexts in a format for classifying the context-dependent phoneme model including an acoustic classification condition and a response corresponding to the classification condition (query) (hereinafter, “conditional response”), for each of the phoneme contexts. In FIG. 3, a classification condition set is described in an upper row, and the phoneme contexts are described in a left column in the phoneme-model classification-condition storage unit 101. In the classification condition set, respective classification conditions are stored respectively in a query form. The phoneme-model classification-condition storage unit 101 stores any of positive “Y” or negative “N” corresponding to each query as the conditional response for each phoneme context.

As the classification condition (query) relating to the phoneme context stored in the phoneme-model classification-condition storage unit 101, for example, there is a classification condition (query) relating to the acoustic characteristic of the phoneme context.

The acoustic characteristic includes all the acoustic characteristics associated with a speech uttered by a user, and also includes a linguistic characteristic or a phoneme class phoneme in the speech, and includes, for example, whether the speech is voiced or voiceless, whether it is an alveolar, and whether it is a predetermined phoneme.

Query “R_Voiced?” shown in FIG. 3 is a classification condition for performing classification based on whether the right phoneme context is voiced. Positive (Y) is set to right phoneme contexts “*+b”, “*+d”, and “*+z” which are voiced and negative (N) is set to right phoneme contexts “*+p”, “*+t”, and “*+s” which are voiceless with respect to query “R_Voiced?”.

Similarly, query “R_Plosive?” is a classification condition for performing classification based on whether the right phoneme context is plosive, and Query “R_Alveolar?” is a query asking whether the right phoneme context is alveolar. The conditional responses to these queries are stored in the phoneme-model classification-condition storage unit 101 with respect to all the right phoneme contexts.

Although not shown in FIG. 3, a classification condition for performing classification according to whether the phoneme context is a specific phoneme can be set. For example, the classification condition for performing classification based on whether the right phoneme context is phoneme “p” is set as query “R_p?”, and the response to the query can be set to each right phoneme context. In this case, with respect to the query “R_p?”, a positive (Y) response is set to only right phoneme context “*+p” and a negative (N) response is set to other right phoneme contexts.

Further, the query relating to the linguistic characteristic of the left phoneme context and the response to the query can be stored in the phoneme-model classification-condition storage unit 101. In the phoneme-model classification-condition storage unit 101 according to the first embodiment, the classification condition for classifying the context-dependent phoneme models can be set based on the phoneme context, not limited to the query and the response case to the query shown in FIG. 3.

The input unit 105 inputs the set of context-dependent phoneme models. In the first embodiment, it is assumed that the input unit 105 inputs the set of context-dependent phoneme models shown in FIG. 2.

The input unit 105 can input the set of context-dependent phoneme models according to any conventionally used method. For example, the input unit 105 can input the set of context-dependent phoneme models from an external device connected thereto via a network or the like. Further, the input unit 105 can input the set of context-dependent phoneme models from a portable storage medium.

In the first embodiment, a hidden Markov model (HMM) is used as the context-dependent phoneme model. The HMM is defined by at least one state Si, a set SS of initial states and a set SF of final states, transition probability Aji from one state Sj to itself or another state Si, and output probability Pi(X) of a speech characteristic vector X in the one state Si. 1≦i≦NS and 1≦j≦NS are established here, where NS is the total number of states constituting the HMM.

The HMM shown in FIG. 4 has the number of states NS=3. In FIG. 4, a description of a transition path in which transition probability does not have a significant value, that is, the transition probability is always “0” is omitted. The HMM shown in FIG. 4 is an exemplary HMM typically used in this technical field, and the HMM has a topology referred to as Left-to-Right type. That is, it is an exemplary HMM having transition probability Aji significant only in the transition path (i, j), in which the number of elements of the set SS of the initial states and the set SS of the final states is respectively 1, and i=j, or i=j+1.

In the first embodiment, explanations are given with an assumption that the HMM shown in FIG. 4 is used as the context-dependent phoneme model. However, the context-dependent phoneme model usable in the first embodiment is not limited to the HMM shown in FIG. 4, and the HMM in another format can be used. As the context-dependent phoneme model, an arbitrary context-dependent phoneme model used in this technical field can be used.

As in the first embodiment, when the HMM having at least two states shown in FIG. 4 is used, the decision tree clustering is performed for each state present at the same position of the HMM. For example, in the case of the HMM shown in FIG. 4, the decision tree clustering is performed with respect to the state of the HMM for each of the first state S1, the second state S2, and the third state S3. In other words, when the HMM in FIG. 4 is used, the first clustering unit 106 and the second clustering unit 109 in the phoneme model clustering apparatus 100 respectively perform the decision tree clustering for the number of states, that is, NS times.

The first clustering unit 106 performs the decision tree clustering with respect to at least one set of context-dependent phoneme models having the central phoneme. The decision tree clustering performed by the first clustering unit 106 is performed for each set of context-dependent phoneme models having the common central phoneme with respect to all the context-dependent phoneme models input by the input unit 105.

However, when there is only one context-dependent phoneme model having a certain central phoneme, the first clustering unit 106 does not execute the decision tree clustering, and outputs a cluster including the one context-dependent phoneme model as a clustering result.

The first clustering unit 106 according to the first embodiment refers to the phoneme-model classification-condition storage unit 101, to perform the decision tree clustering of the context-dependent phoneme models with respect to the set of context-dependent phoneme models having a certain central phoneme, based on the conditional response corresponding to the classification condition associated with the phoneme context included in the respective context-dependent phoneme models. As a result of the decision tree clustering performed by the first clustering unit 106, a cluster including the context-dependent phoneme models having a common central phoneme and a common acoustic characteristic is generated.

As a specific method of the decision tree clustering executed by the first clustering unit 106, any methods can be used regardless of whether it is a well known one, so long as the decision tree clustering is performed with respect to the set of context-dependent phoneme models for each central phoneme. For example, the method described in “Tree-Based State Tying for High Accuracy Acoustic Modeling” or JP-A 2001-100779 (KOKAI) can be used.

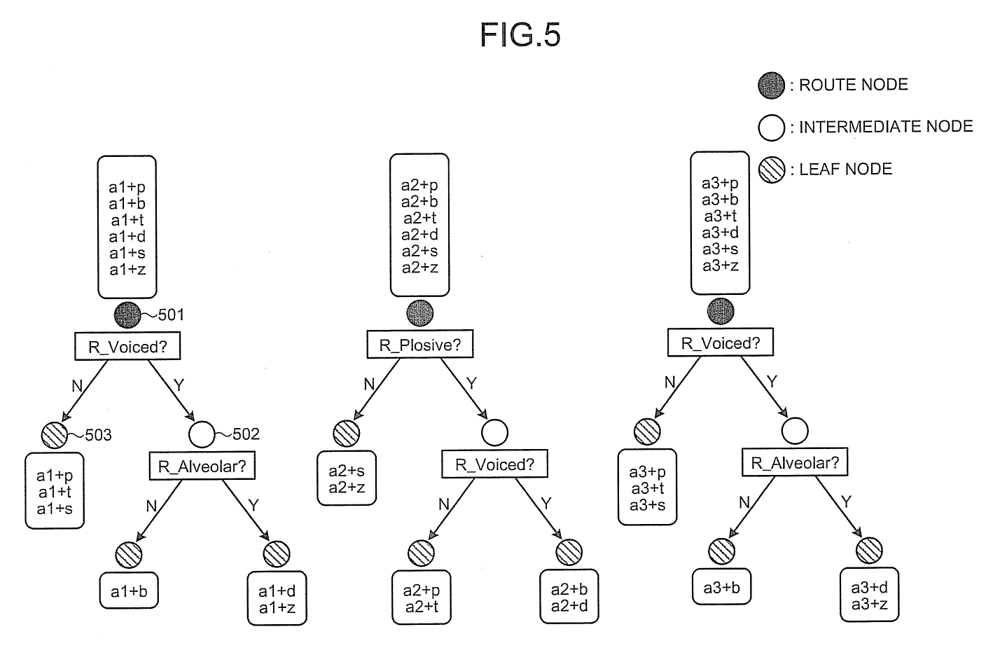

An outline of the decision tree clustering in the first clustering unit 106 is explained next with reference to FIG. 5. As shown in FIG. 5, the first clustering unit executes the decision tree clustering for each set of context-dependent phoneme models having the common central phoneme (e.g., (a1+p, a1+b, a1+t, a1+d, a1+s, a1+z), (a2+p, a2+b, a2+t, a2+d, a2+s, a2+z), and (a3+p, a3+b, a3+t, a3+d, a3+s, a3+z), among the sets of the context-dependent phoneme models input by the input unit 105.

The outline of the decision tree clustering performed with respect to the set of context-dependent phoneme models having the central phoneme of “a1” (a1+p, a1+b, a1+t, a1+d, a1+s, a1+z) is explained, among the sets of the context-dependent phoneme models input by the input unit 105.

First, the first clustering unit 106 generates a route node (node 501) including the set of all the context-dependent phoneme models. In an example shown in FIG. 5, the route node is indicated by a black circle, and the set of context-dependent phoneme models included in the route node is described above the black circle.

The first clustering unit 106 then specifies a query for performing the best classification with respect to the set of context-dependent phoneme models based on mutual similarity of the context-dependent phoneme models included in the route node, from the classification condition set associated with the phoneme context stored in the phoneme-model classification-condition storage unit 101. The best classification is assumed to be determined according to a mode actually performed, and explanations thereof will be omitted. The first clustering unit 106 classifies the set of context-dependent phoneme models included in the route node based on the conditional response corresponding to the specified query. The first clustering unit 106 then generates a new node including the set of the classified respective context-dependent phoneme models (e.g., node 502 and node 503).

In the example shown in FIG. 5, the first clustering unit 106 specifies a query “R_Voiced?” associated with the right phoneme context with respect to the route node 501, to obtain a set of context-dependent phoneme models (a1+b, a1+d, a1+z) having the right phoneme context with the positive (Y) conditional response being set with respect to the query. The first clustering unit 106 then generates a new node 502 ahead of a directed arc “Y” starting from the route node 501, and stores the set of context-dependent phoneme models (a1+b, a1+d, a1+z) in the node 502.

Likewise, the first clustering unit 106 first obtains a set of context-dependent phoneme models (a1+p, a1+t, a1+s) having the right phoneme context with the negative (N) conditional response being set with respect to the query “R_Voiced?”, generates a new node 503 ahead of a directed arc “N” starting from the route node 501, and stores the set of context-dependent phoneme models (a1+p, a1+t, a1+s) in the node 503.

In this way, the first clustering unit 106 specifies the query for performing the best classification with respect to the set of context-dependent phoneme models based on mutual similarity of the context-dependent phoneme models with respect to the set of context-dependent phoneme models stored in an arbitrary node, from the phoneme-model classification-condition storage unit 101. The first clustering unit 106 executes a process of classifying the sets of context-dependent phoneme models according to the conditional response of the phoneme context corresponding to the specified query, and generating a new node in which the classified set of context-dependent phoneme models is stored. The first clustering unit 106 then repetitively executes the process with respect to a node having no directed arc, and determines whether a suspension condition is satisfied every time a node is generated. When the suspension condition is satisfied, the process is suspended.

Because the first clustering unit 106 executes the above process, a decision tree having a tree structure shown in FIG. 5 can be generated. In this decision tree, a set of context-dependent phoneme models included in a node having no directed arc, that is, in a leaf node is obtained as a clustering result by the first clustering unit 106. In the example shown in FIG. 5, such a leaf node is expressed by crosshatched circle, and the set of context-dependent phoneme models included in the leaf node is described below the leaf node.

In the example of the left decision tree in FIG. 5, the first clustering unit 106 performs classification using the query “R_Voiced?” and the query “R_Alveolar?”, to generate three leaf nodes. The sets of context-dependent phoneme models (a1+p, a1+t, a1+s), (a1+b), and (a1+d, a1+z) included in the leaf nodes become the clustering result in the first clustering unit 106. That is, the first clustering unit 106 outputs the set of context-dependent phoneme models included in each leaf node as one cluster, respectively.

Further, the first clustering unit 106 performs the decision tree clustering as well with respect to the set of context-dependent phoneme models having the central phoneme of “a2” (a2+p, a2+b, a2+t, a2+d, a2+s, a2+z) and the set of context-dependent phoneme models having the central phoneme of “a3” (a3+p, a3+b, a3+t, a3+d, a3+s, a3+z), and outputs the clustering result with respect to the respective sets.

Thus, the set of context-dependent phoneme models in the cluster generated by the decision tree clustering by the first clustering unit 106 has the right phoneme context in which the common conditional response is set with respect to at least one query used in the decision tree clustering. That is, the context-dependent phoneme models in the cluster are a set of context-dependent phoneme models having a common acoustic characteristic (the acoustic characteristic includes the linguistic characteristic and the class) relating to the phoneme context.

Further, at least one query used in a process of obtaining the respective clusters is specified for performing the best classification based on mutual similarity with respect to the set of context-dependent phoneme models stored in an arbitrary node. That is, the set of context-dependent phoneme models in the cluster can be expected to become a set similar to each other.

Thus, because the first clustering unit 106 performs the decision tree clustering, a set of context-dependent phoneme models similar to each other and having the common acoustic characteristic with respect to the phoneme context can be obtained as the clustering result.

It is known that the acoustic characteristic of a certain phoneme largely changes according to the class of a phoneme adjacent to the central phoneme, that is, due to the influence of the phoneme context. Further, it is known that the influence of the phoneme context is different for each class of the central phoneme. Therefore, the first clustering unit 106 executes the decision tree clustering for each set of the context-dependent phoneme models having a different central phoneme, thereby enabling to obtain an optimum clustering result for the central phoneme.

For example, as shown in the decision tree in FIG. 5, a different query is used in the process of the decision tree clustering by the first clustering unit 106 with respect to each of the set of context-dependent phoneme models having the central phoneme of “a1” and the set of context-dependent phoneme models having the central phoneme of “a2”, and as a result, the first clustering unit 106 generates different clustering results with respect to a difference of the phoneme contexts. It is assumed that the first clustering unit 106 performs the decision tree clustering for each state of the HMM, and the decision tree clustering shown in FIG. 3 is performed with respect to the third state of the HMM.

Thus, due to the decision tree clustering by the first clustering unit 106, an optimum clustering result can be output with respect to the difference of the phoneme contexts for each central phoneme different from each other.

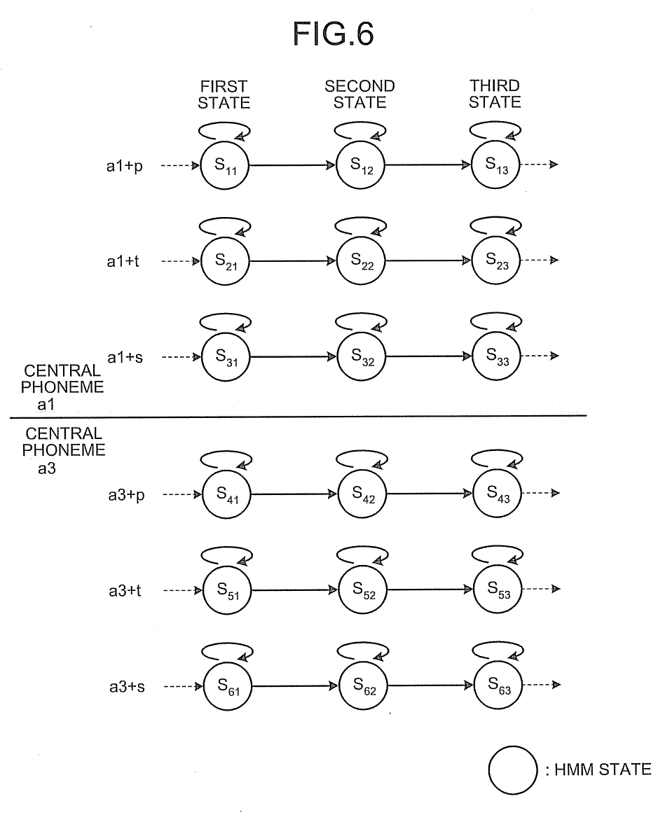

Sharing of the HMM state by the set of context-dependent phoneme models based on the decision tree clustering result obtained by the first clustering unit 106 for each state of the HMM is explained next with reference to FIGS. 6 to 8.

The number of states of the HMM of the context-dependent phoneme models shown in FIG. 6 is assumed to be 3, that is, NS=3, and “a1” and “a3” are central phonemes different from each other, and respectively have phoneme context (*+p, *+t, *+s).

In FIG. 6, 18 HMM states in total are used with respect to 6 context-dependent phoneme models.

The first clustering unit 106 performs the decision tree clustering with respect to the respective states of the HMM for each set of context-dependent phoneme models having the common central phoneme. Accordingly, the respective states of the HMM are common to the set of context-dependent phoneme models included in the cluster obtained by the decision tree clustering.

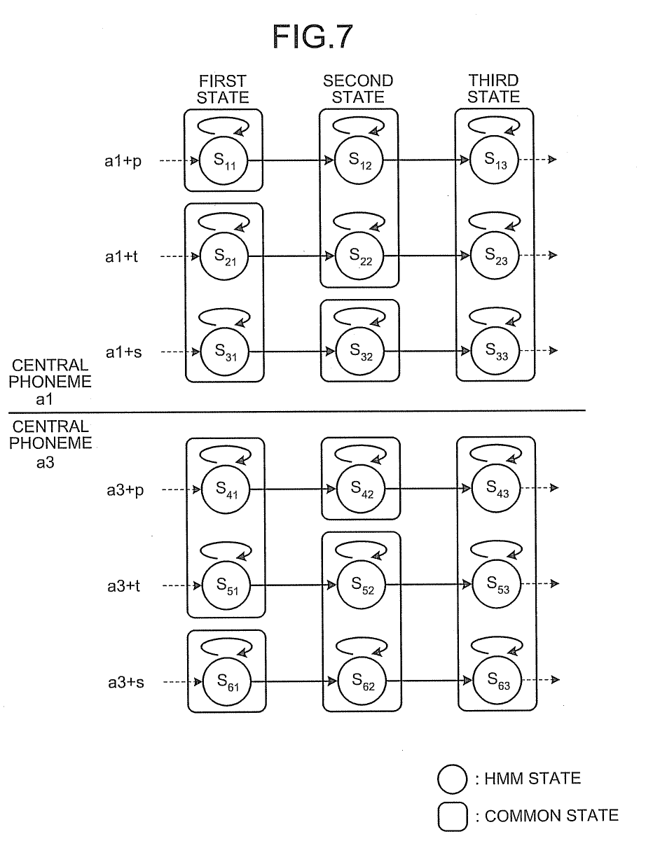

In FIG. 7, the set of the HMM states classified in the same cluster is enclosed by a thick line in the clustering result by the first clustering unit 106.

As shown in FIG. 7, a different clustering result can be obtained according to the state position of the HMM by performing clustering for each state position of the HMM of the context-dependent phoneme models included in the respective clusters. For example, the third state of the clustering result shown in FIG. 7 is classified into (a1+p, a1+t, a1+s) and (a3+p, a3+t, a3+s) as in FIG. 5.

As another example, the first state of the HMM of the set of context-dependent phoneme models (a1+p, a1+t, and a1+s) is classified into two sets of (a1+p) and (a1+t and a1+s). The same classification is made for other states.

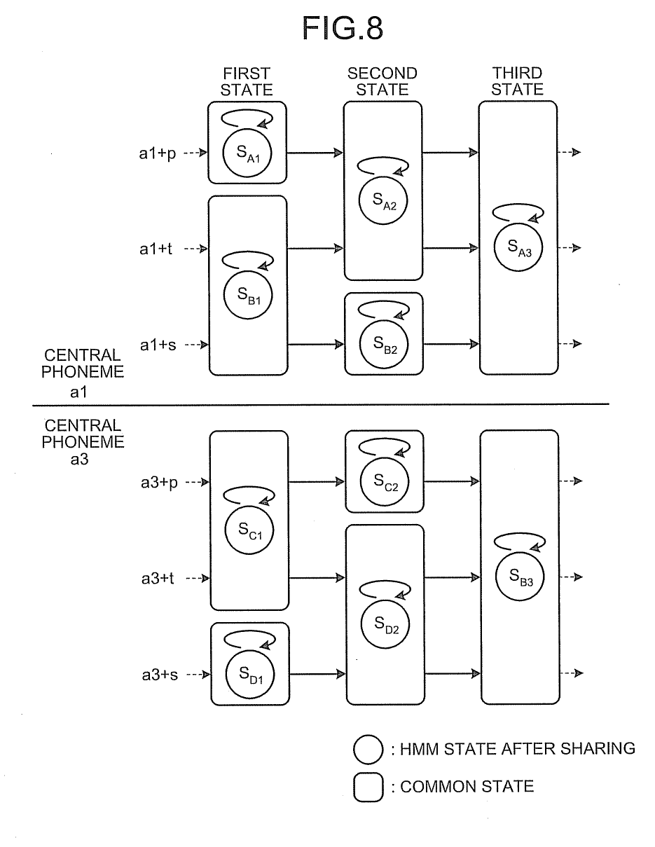

In the first embodiment, more than one HMM states present in the same cluster can be shared based on the clustering result shown in FIG. 7. An example of sharing the speech data for training is explained based on the clustering result obtained by the first clustering unit 106. As shown in FIG. 8, only one HMM state sharing the speech data for training is described for each cluster of each state. That is, the total number of HMM states can be decreased from 18 to 10 by sharing the HMM state based on the clustering result. On the other hand, the phoneme model clustering apparatus 100 can further decrease the total number of the HMM state.

The conditional-response setting unit 107 includes a virtual-phoneme-model defining unit 120 and a virtual-phoneme-model conditional-response setting unit 121, and sets the conditional response corresponding to each classification condition according to the acoustic characteristic of the context-dependent phoneme models included in the cluster generated by the first clustering unit 106 with respect to the respective clusters. At this time, the conditional-response setting unit 107 defines the virtual context-dependent phoneme model with respect to the set of context-dependent phoneme models included in the cluster.

The virtual-phoneme-model defining unit 120 defines a virtual context-dependent phoneme model representing the cluster and a virtual phoneme context held by the virtual context-dependent phoneme model for each cluster obtained by the first clustering unit 106, based on the set of more than one context-dependent phoneme models in the cluster.

In the first embodiment, the virtual phoneme context defined by the virtual-phoneme-model defining unit 120 is referred to as the virtual phoneme context. The virtual context-dependent phoneme model defined by the virtual-phoneme-model defining unit 120 is referred to as the virtual context-dependent phoneme model.

The virtual-phoneme-model defining unit 120 defines the virtual context-dependent phoneme model with respect to respective clusters of “a1+p, a1+t, a1+s”, “a1+b”, “a1+d, a1+z”, “a2+s, a2+z”, “a2+p, a2+t”, “a2+b, a2+d”, “a3+p, a3+t, a3+s), “a3+b”, and “a3+d, a3+z” generated as a result of clustering performed by the first clustering unit 106, shown in FIG. 5.

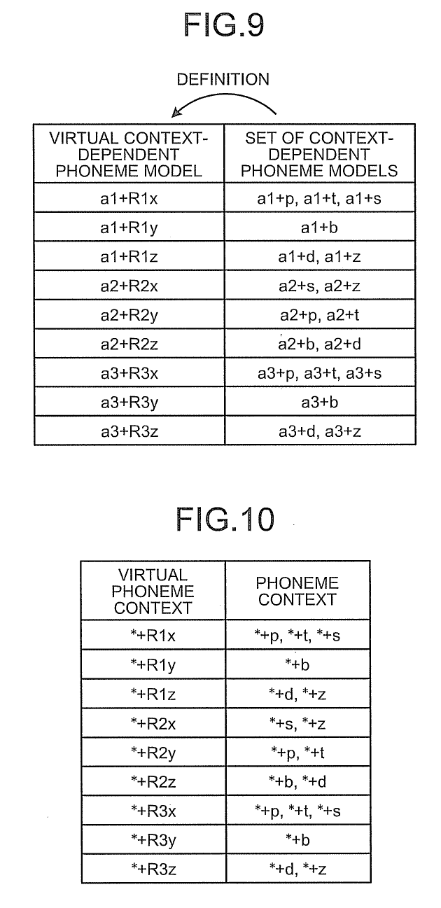

That is, as shown in FIG. 9, the virtual-phoneme-model defining unit 120 defines, for example, a cluster of “a1+p, a1+t, a1+s” as a virtual context-dependent phoneme model “a1+R1X”. The virtual-phoneme-model defining unit 120 also defines other clusters in the same manner. The virtual-phoneme-model defining unit 120 defines virtual context-dependent phoneme models “a1+R1y” and “a1+R1z”, respectively, with respect to the sets “a1+b” and “a1+d, a1+z” of the context-dependent phoneme models. The virtual-phoneme-model defining unit 120 defines the virtual context-dependent phoneme models with respect to other clusters in the same manner.

Right phoneme contexts “*+R1x”, “*+R1y”, and “*+R1z” of the virtual context-dependent phoneme models shown in FIG. 9 become the virtual phoneme contexts, respectively. In this manner, the virtual phoneme context is defined as a representative of all the sets of the phoneme contexts stored in the cluster referred to at the time of defining the virtual context-dependent phoneme model. That is, when the context-dependent phoneme model having the phoneme context is stored in the cluster to be processed, the virtual-phoneme-model defining unit 120 defines the virtual phoneme context with respect to the set of the phoneme contexts held by the respective virtual context-dependent phoneme models.

In FIG. 9, the virtual-phoneme-model defining unit 120 performs the same process with respect to other clusters to generate the set of virtual context-dependent phoneme models (a1+R1x, a1+R1y, a1+R1z, a2+R2x, a2+R2y, a2+R2z, a3+R3x, a3+R3y, a3+R3z).

The virtual phoneme context included in the respective virtual context-dependent phoneme models generated by the virtual-phoneme-model defining unit 120 is explained. As shown in FIG. 10, it is assumed that virtual phoneme context “*+R1x” is defined as a representative of the set of phoneme contexts (*+p, *+t, *+s). It is also assumed here that the virtual phoneme contexts “*+R1y” and “*+R1z” are defined as the representative of the set of phoneme contexts (*+b) and (*+d, *+z). The same applies to other virtual phoneme contexts.

The virtual-phoneme-model conditional-response setting unit 121 sets the conditional response corresponding to the classification condition with respect to the respective virtual phoneme contexts. Therefore, the virtual-phoneme-model conditional-response setting unit 121 first obtains the conditional response common to the sets of phoneme contexts defined as the virtual phoneme context. The common conditional response indicates the conditional response (positive (Y) or negative (N)) corresponding to the classification condition common to all sets of phoneme contexts expressed by the virtual phoneme context stored in the phoneme-model classification-condition storage unit 101.

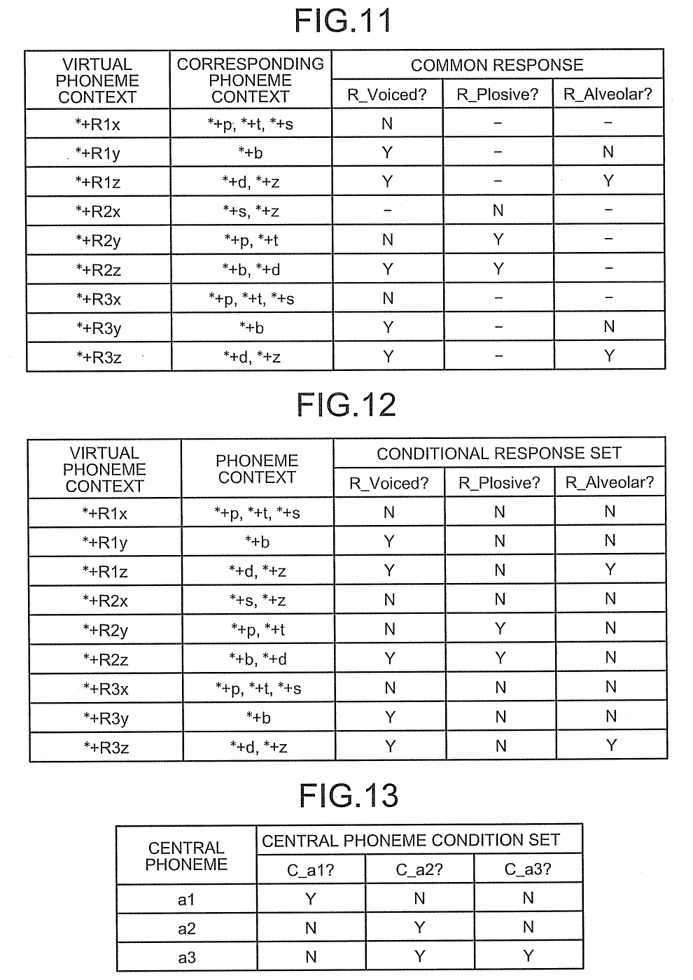

In an exemplary common response of the virtual phoneme context shown in FIG. 11, when the conditional response is common to the sets of phoneme contexts, positive (Y) or negative (N) is set. In a common response, when the conditional response is not common to all the sets of the phoneme contexts, undefined “-” is set.

In FIG. 11, virtual phoneme context “*+R2y” is defined as a representative of the set (“*+p, *+t”) of phoneme contexts. The virtual-phoneme-model conditional-response setting unit 121 sets the conditional response of virtual phoneme context “*+R2y” from the conditional response corresponding to the respective queries of the set (*+p, *+t) of phoneme contexts.

The virtual-phoneme-model conditional-response setting unit 121 sets negative (N), which is the conditional response common to all the sets (*+p, *+t) of the phoneme contexts with respect to the query “R_Voiced?”, and sets positive (Y), which is the conditional response common to all the sets with respect to a query “R_Plosivo?”, among the classification condition sets in the phoneme-model classification-condition storage unit 101. Because the negative (N) conditional response is set to phoneme context “*+p” and positive (Y) conditional response is set to phoneme context “*+t” for the query “R_Alveolar?”, the virtual-phoneme-model conditional-response setting unit 121 sets undefined (-) as the common conditional response. Thus, when there is no conditional response common to all the sets of phoneme contexts, undefined (-) is set.

The virtual-phoneme-model conditional-response setting unit 121 further sets the conditional response common to all the sets (*+p, *+t) of phoneme contexts as a common response to the virtual phoneme context “*+R2y” representing the sets. The same process is performed with respect to other virtual phoneme contexts.

Next, the virtual-phoneme-model conditional-response setting unit 121 interpolates the common response to the virtual phoneme contexts, and sets the conditional response corresponding to the respective classification conditions included in the classification condition set for each virtual phoneme context, based on the common response.

Specifically, the virtual-phoneme-model conditional-response setting unit 121 refers to the common response to the virtual phoneme contexts, and sets positive (Y) to the conditional response with respect to the query, if the common response corresponding to an arbitrary classification condition (query) in the virtual phoneme contexts. The virtual-phoneme-model conditional-response setting unit 121 sets negative (N) to the conditional response with respect to the query, if the common response corresponding to the arbitrary classification condition (query) is negative or undefined (-).

That is, the virtual-phoneme-model conditional-response setting unit 121 interpolates the undefined (-) response, of the common responses of the virtual phoneme contexts shown in FIG. 11, to set the negative (N) response. The virtual-phoneme-model conditional-response setting unit 121 executes such a process with respect to all the virtual phoneme contexts, thereby setting the classification condition set for all the virtual phoneme contexts and the conditional response (positive (Y) or negative (N)) corresponding to the classification condition. The virtual-phoneme-model conditional-response setting unit 121 registers the set content in the virtual-phoneme-model classification-condition storage unit 102.

The virtual-phoneme-model classification-condition storage unit 102 stores the classification condition set and the conditional response corresponding -to the classification condition for each virtual phoneme context registered by the virtual-phoneme-model conditional-response setting unit 121. As shown in FIG. 12, the virtual-phoneme-model classification-condition storage unit 102 stores the classification condition and the conditional response corresponding to the classification condition for each virtual phoneme context.

As shown in FIG. 12, the central-phoneme-class classification-condition storage unit 103 stores the central phoneme conditional set and the conditional response (positive (Y) or negative (N)) corresponding to the individual classification condition (query) included in the central phoneme condition set. The information stored by the central-phoneme-class classification-condition storage unit 103 is substantially the same as the information stored by the phoneme-model classification-condition storage unit 101, however, is different in a feature that the central-phoneme-class classification-condition storage unit 103 stores the condition set relating to the class of the central phoneme and the response corresponding to the query included in the condition set.

As shown in FIG. 13, the central-phoneme-class classification-condition storage unit 103 sets the respective queries included in the central phoneme condition set to a top row, and sets the central phoneme to a far left column. In a field where the row and the column cross each other, the response (positive (Y) or negative (N)) corresponding to the query set in the row is stored for the central phoneme set in the column.

The query relating to the class of the central phoneme stored in the central-phoneme-class classification-condition storage unit 103 asks the class itself of the central phoneme. For example, query “C_a1?” indicated in FIG. 13 is a query asking whether the central phoneme is phoneme “a1”. The same applies to other queries. Although not shown in FIG. 13, a query asking whether the central phoneme has a specific linguistic characteristic can be used. For example, as a query “C_FrontV?”, a query asking whether the central phoneme is a vowel pronounced by an anterior tongue and a response corresponding to the query can be registered in the central-phoneme-class classification-condition storage unit 103.

Further, although not shown in FIG. 13, a query asking whether the central phoneme is a phoneme appearing in a specific language can be registered in the central-phoneme-class classification-condition storage unit 103. For example, as a query “C_Japanese?”, a query asking whether a certain central phoneme “a1” is a phoneme appearing in Japanese and a response corresponding thereto can be registered in the central-phoneme-class classification-condition storage unit 103.

Thus, in the first embodiment, the central phoneme condition set stored in the central-phoneme-class classification-condition storage unit 103 is not limited to the example shown in FIG. 13, and an arbitrary central phoneme condition set associated with various central phoneme classes can be set as the central phoneme condition set associated with the central phoneme class.

The speech-data storage unit 104 stores speech data used for training by the virtual-phoneme-model training unit 108.

The virtual-phoneme-model training unit 108 uses the speech data stored in the speech-data storage unit 104 to train the virtual context-dependent phoneme model generated by the virtual-phoneme-model defining unit 120.

The virtual-phoneme-model training unit 108 according to the first embodiment uses the speech data corresponding to the set of context-dependent phoneme models defined as the virtual context-dependent phoneme model, as the speech data used for training of the virtual context-dependent phoneme model. That is, the virtual-phoneme-model training unit 108 performs training by using the speech data corresponding to the set (a1+p, a1+t, a1+s) of the context-dependent phoneme models, for the virtual context-dependent phoneme model “a1+R1x”. Other virtual context-dependent phoneme models are trained according to the same method.

Because the virtual-phoneme-model training unit 108 performs training for each of the virtual context-dependent phoneme models, it can be expected that the respective virtual context-dependent phoneme models well represent the sets of the context-dependent phoneme models. That is, the accuracy of the decision tree clustering executed by the second clustering unit 109 described later can be improved.

In the phoneme model clustering apparatus 100, it is desired to include the virtual-phoneme-model training unit 108 from the reason described above. However, training of the virtual context-dependent phoneme model in the virtual-phoneme-model training unit 108 is not essential, the virtual-phoneme-model training unit 108 can be omitted according to need.

The second clustering unit 109 executes decision tree clustering with respect to all the sets of virtual context-dependent phoneme models trained by the virtual-phoneme-model training unit 108, based on the query (classification condition) included in the central phoneme condition relating to the central phoneme class stored in the central-phoneme-class classification-condition storage unit 103 and a conditional response corresponding thereto, and the query included in the classification condition set relating to the virtual phoneme context stored in the virtual-phoneme-model classification-condition storage unit 102 and a conditional response corresponding thereto.

The second clustering unit 109 executes the decision tree clustering with respect to all the sets of virtual context-dependent phoneme models defined by the virtual-phoneme-model defining unit 120. However, when there is only one virtual context-dependent phoneme model, the second clustering unit 109 does not execute the decision tree clustering, and outputs a cluster including the one virtual context-dependent phoneme model as a clustering result.

The operation of the second clustering unit 109 is explained next. The second clustering unit 109 obtains a query and a corresponding conditional response included in the central phoneme condition from the central-phoneme-class classification-condition storage unit 103 and a query and a corresponding conditional response included in the classification condition set associated with the virtual phoneme context from the virtual-phoneme-model classification-condition storage unit 102, and performs decision tree clustering based on the obtained queries and corresponding responses.

As a specific method of the decision tree clustering executed by the second clustering unit 109, the method used by the first clustering unit 106 can be used. However, in the decision tree clustering in the second clustering unit 109, it is necessary to set one route node to execute the decision tree clustering with respect to all the sets including virtual context-dependent phoneme models. Further, the second clustering unit 109 executes the decision tree clustering based on the query and corresponding response included in the central phoneme condition, and the query and corresponding conditional response included in the classification condition set associated with the virtual phoneme context. This is the different feature of the decision tree clustering executed by the second clustering unit 109 from the decision tree clustering by the first clustering unit 106.

As the specific method of the decision tree clustering executed by the second clustering unit 109, the technique disclosed in “CROSSLINGUAL ACOUSTIC MODELING DEVELOPMENT FOR AUTOMATIC SPEECH RECOGNITION” mentioned above can be used. This literature discloses a method of executing the decision tree clustering with respect to the context-dependent phoneme model as a target, based on a query and a response thereto relating to the central phoneme class and a query and a response thereto relating to the phoneme context. By replacing the context-dependent phoneme model in this literature by the virtual context-dependent phoneme model, and replacing the query relating to the phoneme context in this literature by the classification condition relating to the virtual phoneme context, the second clustering unit 109 can use the technique disclosed in this literature.

The second clustering unit 109 can use a combination of the technique disclosed in “CROSSLINGUAL ACOUSTIC MODELING DEVELOPMENT FOR AUTOMATIC SPEECH RECOGNITION” and the techniques disclosed in “Tree-Based State Tying for High Accuracy Acoustic Modeling” and JP-A 2001-100779 (KOKAI), and the decision tree clustering method well known in this technical field.

However, in “CROSSLINGUAL ACOUSTIC MODELING DEVELOPMENT FOR AUTOMATIC SPEECH RECOGNITION”, only a technique of executing decision tree clustering once with respect to the set of context-dependent phoneme models combined into one regardless of the central phoneme is disclosed. The two-stage execution method of decision tree clustering as in the first embodiment in which after decision tree clustering is performed for each context-dependent phoneme model having the common central phoneme, decision tree clustering is performed with respect to the set of virtual context-dependent phoneme models combined into one regardless of the central phoneme is not disclosed therein. That is, a method of combining the context-dependent phoneme models having the central phoneme different from each other into one cluster after preferentially clustering the set of context-dependent phoneme models having the common central phoneme cannot be derived from the description of “CROSSLINGUAL ACOUSTIC MODELING DEVELOPMENT FOR AUTOMATIC SPEECH RECOGNITION”.

Further, in “CROSSLINGUAL ACOUSTIC MODELING DEVELOPMENT FOR AUTOMATIC SPEECH RECOGNITION”, the virtual context-dependent phoneme model in which the set of context-dependent phoneme models having the common central phoneme is defined is not described, and the classification condition relating to the virtual phoneme context held by the virtual context-dependent phoneme model and a setting method of the classification condition are not disclosed. That is, because the virtual-phoneme-model conditional-response setting unit 121 sets the classification condition and the conditional response with respect to the set of context-dependent phoneme models having the common central phoneme, the second clustering unit 109 can execute the decision tree clustering. Accordingly, the phoneme model clustering apparatus 100 can combine the context-dependent phoneme models having the central phoneme different from each other, giving priority to the set of context-dependent phoneme models having the common central phoneme. Therefore, the accuracy of the decision tree clustering is improved as compared with the technique described in “CROSSLINGUAL ACOUSTIC MODELING DEVELOPMENT FOR AUTOMATIC SPEECH RECOGNITION”.

As explained above, the second clustering unit 109 can obtain the effect of the first embodiment by executing every possible decision tree clustering, regardless of whether the technique is a well known one, if only registration of the classification condition and the conditional response in the virtual-phoneme-model classification-condition storage unit 102 by the virtual-phoneme-model conditional-response setting unit 121 has finished.

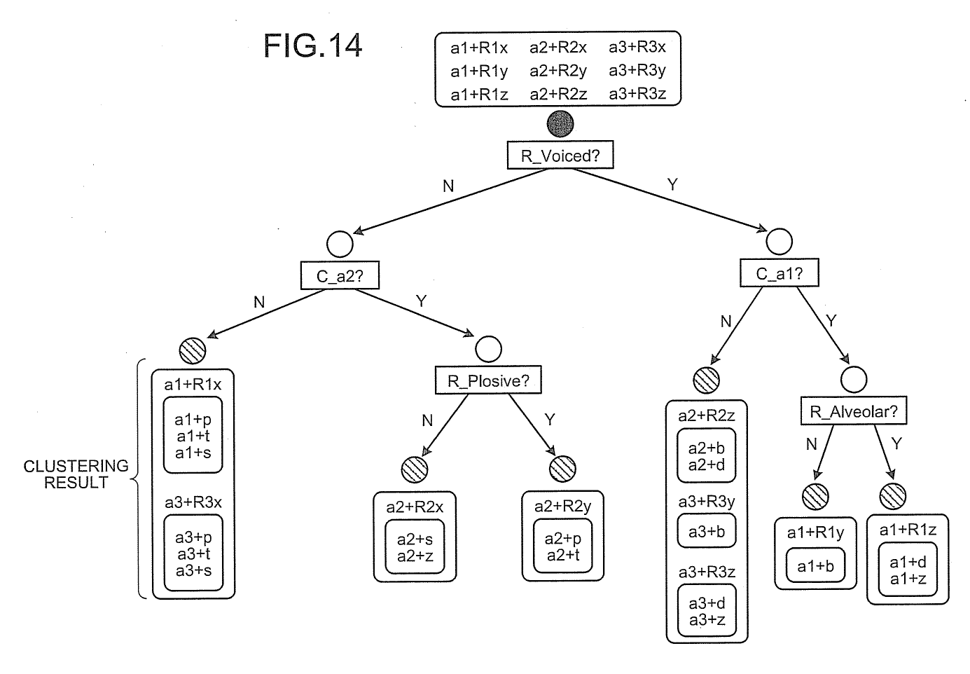

The decision tree clustering by the second clustering unit 109 is explained next with reference to FIG. 14. As shown in FIG. 14, the second clustering unit 109 executes the decision tree clustering with respect to all the sets of virtual context-dependent phoneme models already defined (a1+R1x, a1+R1y, a1+R1z, a2+R2x, a2+R2y, a2+R2z, a3+R3x, a3+R3y, a3+R3z), regardless of whether the central phoneme is a different phoneme.

In FIG. 14, similarly to FIG. 5, the route node is indicated by black circle, and the set of context-dependent phoneme models included in the route node is described above thereof. Further, the leaf node is indicated by crosshatched circle, and the set of context-dependent phoneme models included in the leaf node is described below the leaf node. The set of context-dependent phoneme models defined as each virtual context-dependent phoneme model is also described.

The decision tree clustering by the second clustering unit 109 shown in FIG. 14 is different from that by the first clustering unit 106 shown in FIG. 5 in that the decision tree clustering is executed based on the query and corresponding conditional response included in the classification condition set associated with the virtual phoneme context, and the query and corresponding response included in the central phoneme condition set.

That is, according to the decision tree clustering by the second clustering unit 109, a query for performing the best classification of the sets of virtual context-dependent phoneme models is specified based on mutual similarity of the virtual context-dependent phoneme models with respect to an arbitrary set of virtual context-dependent phoneme models included in an arbitrary node, and a set of virtual context-dependent phoneme models is classified according to a response corresponding to the query.

For example, when the query “R_Voiced?” is specified as the query for performing the best classification with respect to the set of virtual context-dependent phoneme models (a1+R1x, a1+R1y, a1+R1z, a2+R2x, a2+R2y, a2+R2z, a3+R3x, a3+R3y, a3+R3z), as shown in FIG. 12, the second clustering unit 109 classifies the set into a set of virtual context-dependent phoneme models (a1+R1y, a1+R1z, a2+R2z, a3+R3y, a3+R3z) in which positive (Y) is set as the response corresponding to the query, and a set of virtual context-dependent phoneme models (a1+R1x, a2+R2x, a2+R2y, a3+R3x) in which negative (N) is set as the response corresponding to the query.

Further, when a query “C_a2?” shown in FIG. 13 is specified as the query for performing the best classification with respect to the set of virtual context-dependent phoneme models (a1+R1x, a2+R2x, a2+R2y, a3+R3x), the second clustering unit 109 classifies the set into a set of virtual context-dependent phoneme models (a2+R2x, a2+R2y) having the central phoneme with positive (Y) being set as the response corresponding to the query, and a set of virtual context-dependent phoneme models (a1+R1x, a3+R3x) having the central phoneme with negative (N) being set as the response corresponding to the query.

In the decision tree clustering performed by the second clustering unit 109 shown in FIG. 14, after the query for performing the best classification with respect to the set of virtual context-dependent phoneme models included in an arbitrary node is specified, among the classification condition set and the central phoneme condition set associated with the virtual phoneme context, based on the mutual similarity of the sets of virtual context-dependent phoneme models, the decision tree clustering is performed. As a result, a decision tree having the tree structure shown in FIG. 14 can be obtained.

As the clustering result obtained by the second clustering unit 109, the sets of virtual context-dependent phoneme models included in the leaf nodes (a1+R1x, a3+R3x), (a2+R2x), (a2+R2y), (a2+R2z, a3+R3y, a3+R3z), (a1+R1y), (a1+R1z) can be obtained. The second clustering unit 109 then replaces the sets of virtual context-dependent phoneme models included in the leaf nodes by the corresponding sets of context-dependent phoneme models, and outputs the sets as the clustering result.

Further, the second clustering unit 109 performs the decision tree clustering for each HMM state, as in the first clustering unit 106. It is assumed that the decision tree clustering shown in FIG. 14 is performed with respect to the third state of the HMM.

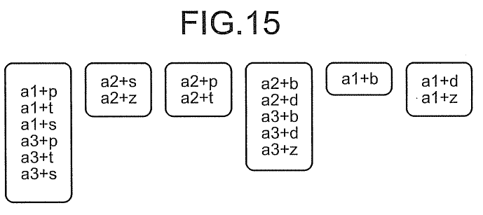

As shown in FIG. 15, the output unit 110 outputs, as the clustering result, the sets of context-dependent phoneme models (a1+p, a1+t, a1+s, a3+p, a3+t, a3+s), (a2+s, a2+z), (a2+p, a2+t), (a2+b, a2+d, a3+b, a3+d, a3+z), (a1+b), (a1+d, a1+z) corresponding to each of the virtual context-dependent phoneme models, according to the clustering result of the second clustering unit 109.

The phoneme model clustering apparatus 100 can output a clustering result obtained by performing appropriate clustering from the input sets of context-dependent phoneme models by having the above configuration.

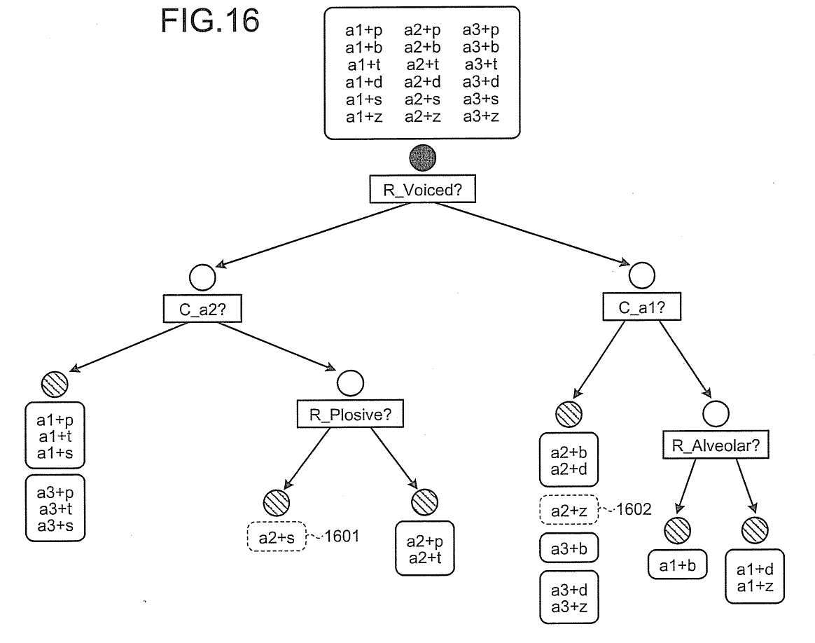

When the decision tree clustering is performed with respect to the sets of context-dependent phoneme models shown in FIG. 2 by using the technique disclosed in “CROSSLINGUAL ACOUSTIC MODELING DEVELOPMENT FOR AUTOMATIC SPEECH RECOGNITION”, a clustering result as shown in FIG. 16 can be obtained. FIG. 14, which is an exemplary clustering result obtained by the phoneme model clustering apparatus 100, is compared with FIG. 16, which is an exemplary clustering result disclosed in “CROSSLINGUAL ACOUSTIC MODELING DEVELOPMENT FOR AUTOMATIC SPEECH RECOGNITION” as a conventional technique. In the conventional clustering result shown in FIG. 16, a set of context-dependent phoneme models (a2+s, a2+z) as an optimum clustering result with respect to the context-dependent phoneme models having the central phoneme “a2” is divided into two clusters as shown by broken line rectangles 1601 and 1602 in FIG. 16.

As shown in the clustering result in FIG. 16, according to the technique described in “CROSSLINGUAL ACOUSTIC MODELING DEVELOPMENT FOR AUTOMATIC SPEECH RECOGNITION”, an optimum clustering result with respect to the context-dependent phoneme models having the common central phoneme cannot be obtained. That is, the phoneme model clustering apparatus 100 can obtain a characteristic effect as compared with “CROSSLINGUAL ACOUSTIC MODELING DEVELOPMENT FOR AUTOMATIC SPEECH RECOGNITION”, such that when decision tree clustering is performed with respect to the sets including the context-dependent phoneme models having the central phoneme different from each other, an optimum clustering result with respect to the context-dependent phoneme models having the common central phoneme can be obtained, and the context-dependent phoneme models having the central phoneme different from each other can be coordinated.

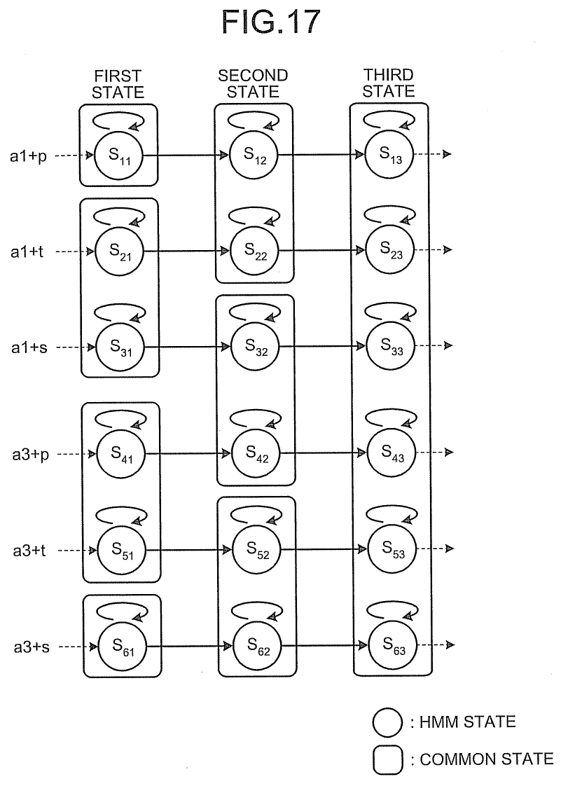

Next, the result of decision tree clustering performed by the second clustering unit 109 with respect to each state shared by the context-dependent phoneme models having the common central phoneme is shown in FIG. 17. In FIG. 17, it is assumed that the decision tree clustering by the second clustering unit 109 is performed with respect to each HMM state. That is, after the clustering results by the first clustering unit 106 are coordinated, the second clustering unit 109 performs the decision tree clustering. Accordingly, as shown in FIG. 17, a clustering result in which the state is shared by the context-dependent phoneme models having different central phonemes “a1” and “a3” can be obtained.

In the clustering result exemplified in FIG. 17, similarly to the result in FIG. 14, the set (a1+p, a1+t, a1+s, a3+p, a3+t, a3+s) is coordinated as the clustering result in the third state of the HMM, and the set (a1+s, a3+p) is coordinated as the clustering result in the second state of the HMM. Thus, the same process can be performed for each state of other context-dependent phoneme models.

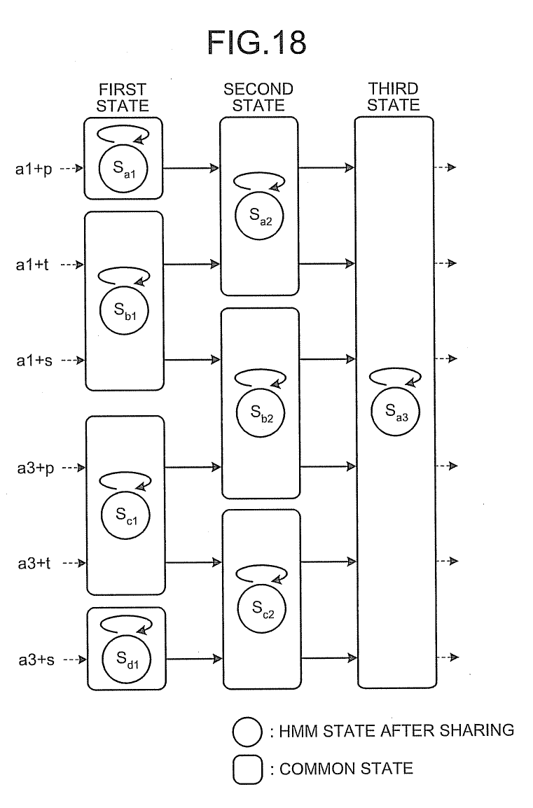

In FIG. 18, similarly to FIG. 8, only one state of the HMM is shown for each cluster. In the clustering result shown in FIG. 18, the total number of HMM states is reduced to 8. That is, in the clustering result shown in FIG. 18, reduction of the states is realized more than in the clustering result shown in FIG. 8.

That is, the HMM state can be shared by a plurality of context-dependent phoneme models according to the clustering result performed by the phoneme model clustering apparatus 100, thereby enabling to perform highly accurate training of the context-dependent phoneme models, while efficiently avoiding the problem of the speech data for training being insufficient or absent.

In FIGS. 17 and 18, the first states of the HMM in the respective sets (a1+p, a1+t, a1+s) and (a3+p, a3+t, a3+s) of context-dependent phoneme models indicate the central phoneme, and are quite different states. Accordingly, it is ensured that there is no context-dependent phoneme model sharing the third state of the same HMM between an arbitrary context-dependent phoneme model included in the set (a1+p, a1+t, a1+s) and an arbitrary context-dependent phoneme model included in the set (a3+p, a3+t, a3+s). That is, three different HMM states can be used with respect to the context-dependent phoneme models having the central phoneme different from each other. That is, three HMM states different from each other can be used for discriminating the central phonemes “a1” and “a3” from each other.

The execution result of the decision tree clustering explained in the first embodiment is shown as an example. The phoneme model clustering apparatus 100 can execute the decision tree clustering with respect to the HMM having an arbitrary number of states and an arbitrary state position of the HMM.

For example, the phoneme model clustering apparatus 100 can execute the decision tree clustering with respect to the set including the context-dependent phoneme models having the central phoneme different from each other, at all state positions of the HMM including the first state of the HMM. Further, the decision tree clustering can be executed with respect to only the first state of the HMM.

The phoneme-model classification-condition storage unit 101, the central-phoneme-class classification-condition storage unit 103, the virtual-phoneme-model classification-condition storage unit 102, and the speech-data storage unit 104 can be constructed by any generally used storage medium such as a hard disk drive (HDD), a random access memory (RAM), an optical disk or a memory card.

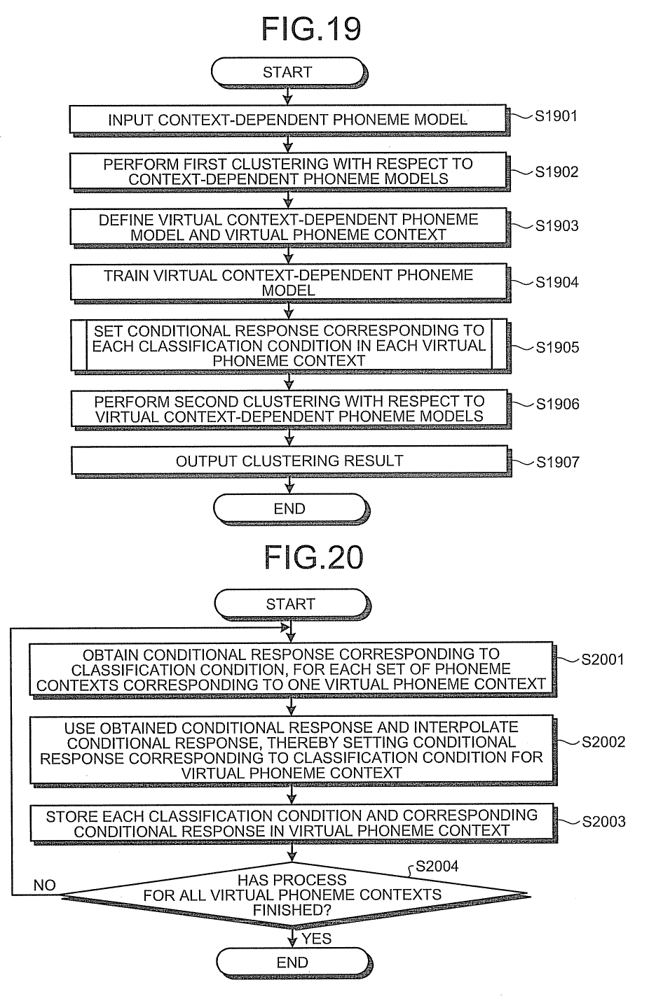

A clustering process procedure by the phoneme model clustering apparatus 100 according to the first embodiment is explained with reference to FIG. 19.

The input unit 105 first inputs a plurality of context-dependent phoneme models as a clustering target (Step S1901). To do this, the input unit 105 inputs two or more sets of context-dependent phoneme models having the central phoneme different from each other.

Next, the first clustering unit 106 executes first decision tree clustering with respect to the context-dependent phoneme models input by the input unit 105 for each set of context-dependent phoneme models having the common central phoneme (Step S1902). The first clustering unit 106 generates a cluster including the context-dependent phoneme models having a common central phoneme and a common acoustic characteristic by performing the first decision tree clustering based on the classification condition stored in the phoneme-model classification-condition storage unit 101 and the conditional response corresponding to the classification condition.

The virtual-phoneme-model defining unit 120 then defines a virtual phoneme context expressing a set of phoneme contexts of the context-dependent phoneme model included in the cluster and a virtual context-dependent phoneme model expressing a set of context-dependent phoneme models included in the cluster, for each cluster generated by the first clustering unit 106 (Step S1903).

Next, the virtual-phoneme-model training unit 108 refers to the speech data stored in the speech-data storage unit 104 to train the acoustic characteristic of the virtual context-dependent phoneme model based on the speech data corresponding to each set of context-dependent phoneme models defined as the virtual context-dependent phoneme model (Step S1904).

The virtual-phoneme-model conditional-response setting unit 121 then sets a conditional response corresponding to each classification condition included in the classification condition set, for each virtual phoneme context defined by the virtual-phoneme-model defining unit 120 (Step S1905).

Next, the second clustering unit 109 executes the second decision tree clustering with respect to all the sets of virtual context-dependent phoneme models trained by the virtual-phoneme-model training unit 108, based on the conditional response corresponding to the query included in the central phoneme condition set stored in the central-phoneme-class classification-condition storage unit 103 and the conditional response corresponding to the classification condition included in the classification condition set stored in the virtual-phoneme-model classification-condition storage unit 102 (Step S1906).

The output unit 110 outputs then sets of context-dependent phoneme models as a clustering result, in a unit of set of virtual context-dependent phoneme models generated by the second clustering unit 109 (Step S1907). That is, the output unit 110 outputs the sets of context-dependent phoneme models as shown in FIG. 15 as the clustering result.

A setting procedure of the conditional response corresponding to each classification condition at Step S1905 in FIG. 19 in the virtual-phoneme-model conditional-response setting unit 121 according to the first embodiment is explained next with reference to FIG. 20.

First, the virtual-phoneme-model conditional-response setting unit 121 refers to the phoneme-model classification-condition storage unit 101 to obtain the conditional response common to the sets of phoneme contexts defined as the virtual phoneme context (Step S2001).

Next, the virtual-phoneme-model conditional-response setting unit 121 interpolates the common response to the virtual phoneme contexts, to set the conditional response corresponding to each classification condition for the virtual phoneme context (Step S2002).

The virtual-phoneme-model conditional-response setting unit 121 then registers the classification condition set and the conditional response corresponding to the classification condition (positive (Y) or negative (N)) for the virtual phoneme context in the virtual-phoneme-model classification-condition storage unit 102 (Step S2003).

The virtual-phoneme-model conditional-response setting unit 121 then determines whether the process has finished for all the virtual phoneme contexts (Step S2004). If not (NO at Step S2004), the virtual-phoneme-model conditional-response setting unit 121 starts a process from Step S2001 with respect to an unprocessed virtual phoneme context as a processing target.

When determining that the process has finished for all the virtual phoneme contexts (YES at Step S2004), the virtual-phoneme-model conditional-response setting unit 121 finishes the process.

It can be confirmed from a comparison between FIG. 5 depicting the result of first decision tree clustering by the first clustering unit 106 and FIG. 14 depicting the result of second decision tree clustering by the second clustering unit 109 that the phoneme model clustering apparatus 100 holds the result of the first decision tree clustering in the result of the second decision tree clustering.

That is, the phoneme model clustering apparatus 100 can provide an optimum clustering result with respect to all the context-dependent phoneme models including the central phoneme different from each other by coordinating the context-dependent phoneme models having the central phoneme different from each other, while maintaining the optimum clustering result performed for each central phoneme.

As described above, the phoneme model clustering apparatus 100 can perform processing, assuming that more than one state of the HMM present in one cluster is similar to that of the HMM of another context-dependent phoneme model. That is, because training can be performed with one piece of speech data for training as the HMM state of respective context-dependent phoneme models, the accuracy of the HMM state obtained by the training is improved.

Further, in the phoneme model clustering apparatus 100, it can be expected that the amount of speech data that can be used for each state of the HMM increases by sharing the HMM state based on the clustering result. Therefore, the problem of the speech data for training being insufficient or absent at the time of training the context-dependent phoneme model can be avoided.

In addition, in the phoneme model clustering apparatus 100, by sharing the HMM state based on the clustering result, highly accurate context-dependent phoneme model can be trained, while avoiding the problem of the speech data for training being insufficient or absent.

In the first embodiment, the virtual-phoneme-model conditional-response setting unit 121 sets the similar conditional response corresponding to the classification condition to that in the phoneme-model classification-condition storage unit 101. However, the classification condition and the setting method of the conditional response are not limited thereto, and various other methods can be used. In a second embodiment of the present invention, a classification condition and a setting method of the conditional response different from the first embodiment are explained.

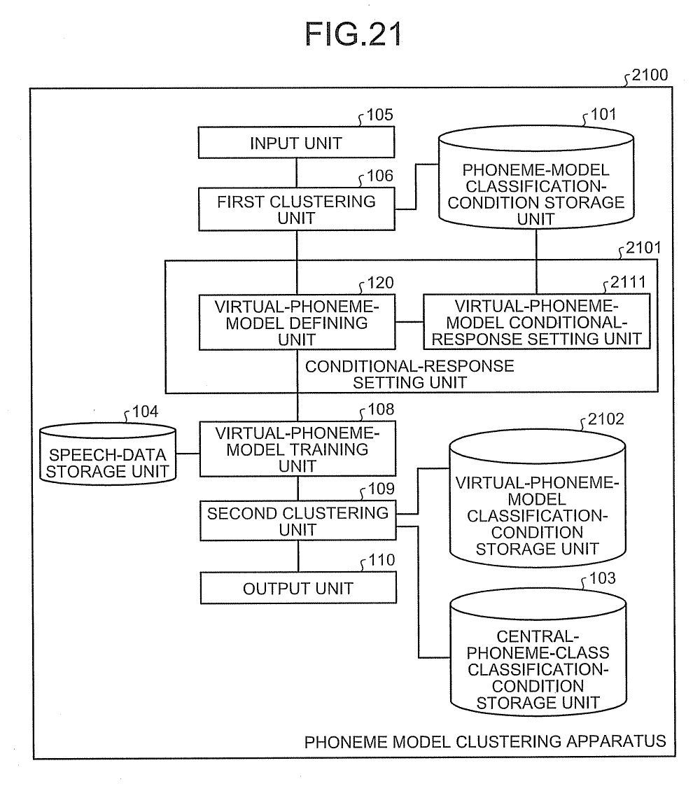

A phoneme model clustering apparatus 2100 according to the second embodiment shown in FIG. 21 is different from the phoneme model clustering apparatus 100 according to the first embodiment only in a feature that it includes a conditional-response setting unit 2101 that performs a process different from that of the conditional-response setting unit 107, a virtual-phoneme-model classification-condition storage unit 2102 having a data structure different from that of the virtual-phoneme-model classification-condition storage unit 102, and a second clustering unit 2103 that performs a process different from that of the second clustering unit 109. Explanations of the configuration of the phoneme model clustering apparatus 2100 common to the explanations of the phoneme model clustering apparatus 100 according to the first embodiment will be omitted.

The conditional-response setting unit 2101 includes the virtual-phoneme-model defining unit 120 and a virtual-phoneme-model conditional-response setting unit 2111.

The virtual-phoneme-model conditional-response setting unit 2111 generates a new set of queries (classification conditions) asking whether the conditional response relating to the respective classification conditions in the classification condition set stored in the phoneme-model classification-condition storage unit 101 is positive (Y) or negative (N) as the classification conditions for the virtual phoneme contexts, and sets a conditional response corresponding to each query (classification condition) in the generated query set.

Specifically, the virtual-phoneme-model conditional-response setting unit 2111 generates a new classification condition set asking whether a response common to a certain query is positive (Y) or negative (N), based on the classification condition set stored in the phoneme-model classification-condition storage unit 101, as a new classification condition set with respect to the virtual phoneme context.

For example, the virtual-phoneme-model conditional-response setting unit 2111 generates a new query “R_Voiced_Y?” asking whether the common response to the query is positive (Y) and a new query “R_Voiced_N?” asking whether the common response to the query is negative (N). The virtual-phoneme-model conditional-response setting unit 2111 also generates a new query asking whether the common response to the query is positive (Y) and a new query asking whether it is negative (N) with respect to other queries shown in FIG. 11.

Further, the virtual-phoneme-model conditional-response setting unit 2111 generates a conditional response corresponding to the newly generated query (classification condition) based on the common conditional response shown in FIG. 11. For example, the virtual-phoneme-model conditional-response setting unit 2111 sets positive (Y) to each of the virtual phoneme contexts (*+R1y, *+R1z, *+R2z, *+R3y, *+R3z) in which the common response to the query “R_Voiced?” is positive (Y) as the conditional response corresponding to the newly generated query “R_Voiced_Y?”, and sets negative (N) to other virtual phoneme contexts as the conditional response corresponding to the newly generated query “R_Voiced_Y?”.

As another example, the virtual-phoneme-model conditional-response setting unit 2111 sets positive (Y) as the conditional response corresponding to the newly generated query “R_Voiced_N?” in each of the virtual phoneme contexts (*+R1x, *+R2y, *+R3x) in which the common response to the query “R_Voiced?” is negative (N), and sets negative (N) to other virtual phoneme contexts as the conditional response corresponding to the newly generated query “R_Voiced_N?”. The virtual-phoneme-model conditional-response setting unit 2111 then performs the same process with respect to other queries stored in the phoneme-model classification-condition storage unit 101. The conditional-response setting unit 2101 registers the generated query (classification condition) and the corresponding conditional response in the virtual-phoneme-model classification-condition storage unit 2102.

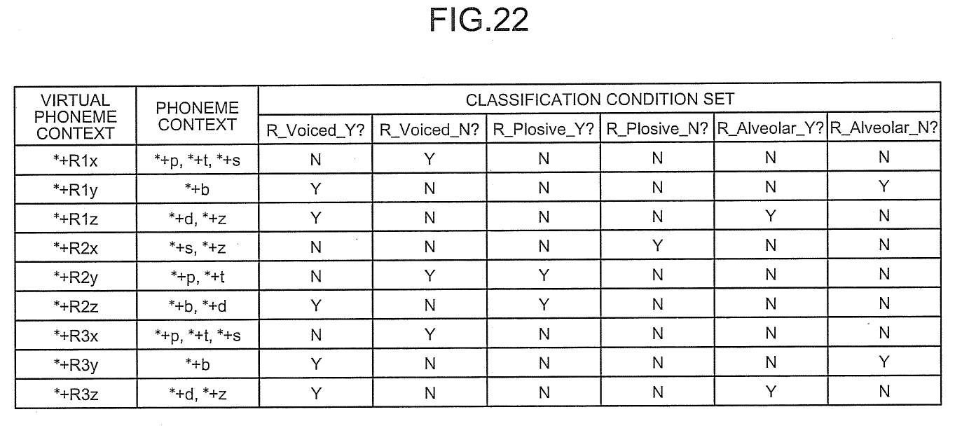

The virtual-phoneme-model classification-condition storage unit 2102 stores the classification condition generated by the conditional-response setting unit 2101 and the conditional response corresponding to the classification condition. As shown in FIG. 22, the virtual-phoneme-model classification-condition storage unit 2102 stores the classification condition set and the conditional responses corresponding to the classification conditions for each virtual phoneme context registered by the virtual-phoneme-model conditional-response setting unit 2111.

The second clustering unit 2103 executes decision tree clustering with respect to all the sets of virtual context-dependent phoneme models trained by the virtual-phoneme-model training unit 108, based on the query included in the central phoneme condition relating to the central phoneme class stored in the central-phoneme-class classification-condition storage unit 103 and a response corresponding thereto, and the query included in the classification condition set relating to the virtual phoneme context stored in the virtual-phoneme-model classification-condition storage unit 2102 and a conditional response corresponding thereto. The decision tree clustering method is the same as that in the first embodiment, and therefore explanations thereof will be omitted.

The phoneme model clustering apparatus 2100 according to the second embodiment performs a process according to a flowchart shown in FIG. 19. However, in the phoneme model clustering apparatus 2100, the process at Step S1905 in FIG. 19 is different from that of the phoneme model clustering apparatus 100 according to the first embodiment.

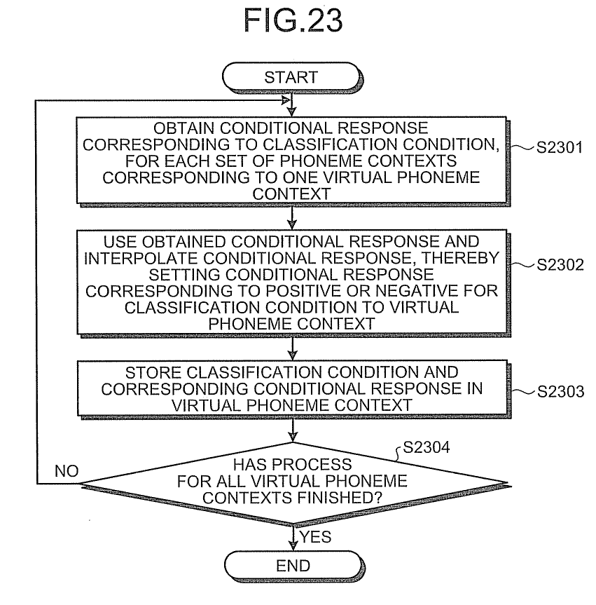

Therefore, a setting procedure of the conditional response corresponding to each classification condition at Step S1905 in FIG. 19 in the virtual-phoneme-model conditional-response setting unit 2111 according to the second embodiment is explained with reference to FIG. 23.

As for Steps S2301, S2303, and S2304 in FIG. 23, they are the same as Steps S2001, S2003, and S2004 in FIG. 20, and therefore explanations thereof will be omitted. Step S2302 executed by the virtual-phoneme-model conditional-response setting unit 2111 is explained below.

The virtual-phoneme-model conditional-response setting unit 2111 generates a new query set asking whether a response common to the virtual phoneme context is positive (Y) or negative (N) for each of the classification conditions relating to the response, and sets a conditional response corresponding to each of the newly generated queries (Step S2302).

With respect to the respective classification conditions stored in the phoneme-model classification-condition storage unit 101, the conditional response common to the virtual phoneme context is classified into three groups of positive (Y), negative (N), and undefined (-). In the phoneme model clustering apparatus 2100, however, by generating a new query asking whether the common response is positive (Y) or negative (N), the virtual context-dependent phoneme models can be classified into a group having positive (Y) as the common response and the other group, and into a group having negative (N) and the other group.

By setting the classification condition set capable of classifying the virtual context-dependent phoneme models and the conditional response corresponding to the classification condition (query), the virtual context-dependent phoneme models can be classified in more detail, as compared with the first embodiment. Accordingly, clustering accuracy by the phoneme model clustering apparatus 2100 can be further improved.

In a third embodiment of the present invention, similarly to the second embodiment, a classification condition and a setting method of a conditional response different from the first embodiment are explained.

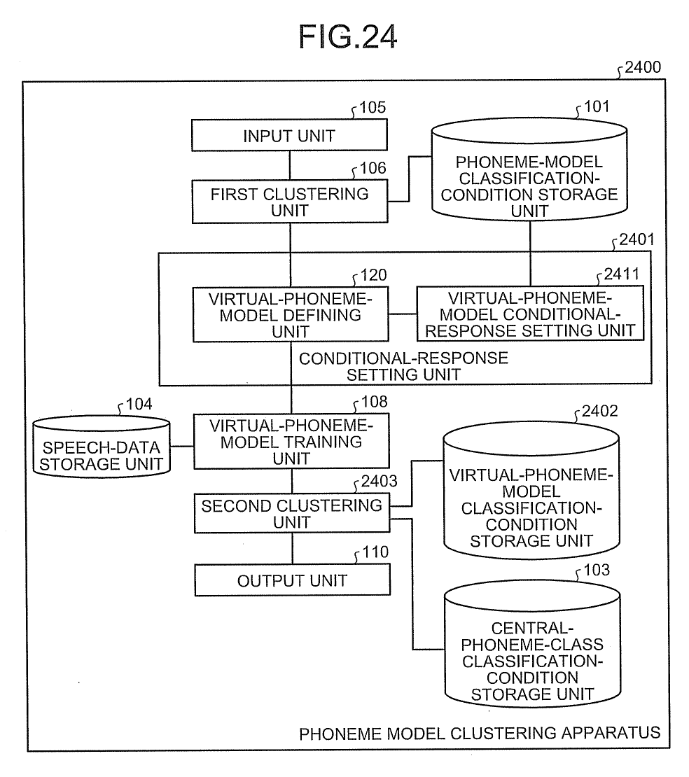

A phoneme model clustering apparatus 2400 shown in FIG. 24 is different from the phoneme model clustering apparatus 100 according to the first embodiment only in a feature that it includes a conditional-response setting unit 2401 that performs a process different from that of the conditional-response setting unit 107, a virtual-phoneme-model classification-condition storage unit 2402 having a data structure different from that of the virtual-phoneme-model classification-condition storage unit 102, and a second clustering unit 2403 that performs a process different from that of the second clustering unit 109. Explanations of the configuration of the phoneme model clustering apparatus 2400 common to the explanations of the phoneme model clustering apparatus 100 according to the first embodiment will be omitted.

The conditional-response setting unit 2401 includes the virtual-phoneme-model defining unit 120 and a virtual-phoneme-model conditional-response setting unit 2411.

The virtual-phoneme-model conditional-response setting unit 2411 generates a new set of queries (classification conditions) asking whether the conditional response relating to the respective classification conditions in the classification condition set stored in the phoneme-model classification-condition storage unit 101 is positive (Y), negative (N), or undefined (-) as the classification conditions for the virtual phoneme contexts, and sets a conditional response corresponding to each query (classification condition) in the generated query set.

Specifically, the virtual-phoneme-model conditional-response setting unit 2411 generates a new classification condition set asking whether a response common to a certain query is positive (Y), negative (N), or undefined (-) based on the classification condition set stored in the phoneme-model classification-condition storage unit 101, as a new classification condition set with respect to the virtual phoneme context.

For example, the virtual-phoneme-model conditional-response setting unit 2411 generates a new query “R_Voiced_Y?” asking whether the common response to the query is positive (Y), a new query “R_Voiced_N?” asking whether the common response to the query is negative (N), and a new query “R_Voiced_U?” asking whether the common response to the query is undefined (-). The virtual-phoneme-model conditional-response setting unit 2411 also generates a new query asking whether the common response is positive (Y), a new query asking whether it is negative (N), or a new query asking whether it is undefined (-) with respect to other queries shown in FIG. 11.

Further, the virtual-phoneme-model conditional-response setting unit 2411 generates a conditional response corresponding to the newly generated query (classification condition) based on the common conditional response shown in FIG. 11. For example, the virtual-phoneme-model conditional-response setting unit 2411 sets positive (Y) to the virtual phoneme context (*+R2z) in which the common response to the query “R_Voiced?” is undefined (-) as the conditional response corresponding to the newly generated query “R_Voiced_U?”, and sets negative (N) to other virtual phoneme contexts as the conditional response corresponding to the newly generated query “R_Voiced_Y?”.

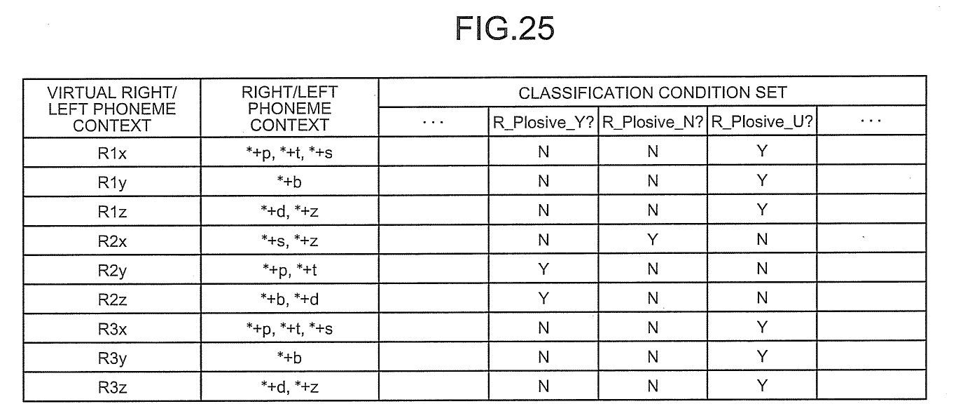

The virtual-phoneme-model classification-condition storage unit 2402 stores the classification condition generated by the virtual-phoneme-model conditional-response setting unit 2411 and the conditional response corresponding to the classification condition. As shown in FIG. 25, the virtual-phoneme-model classification-condition storage unit 2402 stores the classification condition set and the conditional responses corresponding to the classification conditions for each virtual phoneme context registered by the virtual-phoneme-model conditional-response setting unit 2411.

The second clustering unit 2403 executes decision tree clustering with respect to all the sets of virtual context-dependent phoneme models trained by the virtual-phoneme-model training unit 108, based on the query included in the central phoneme condition relating to the central phoneme class stored in the central-phoneme-class classification-condition storage unit 103 and a response corresponding thereto, and the query included in the classification condition set relating to the virtual phoneme context stored in the virtual-phoneme-model classification-condition storage unit 2402 and a conditional response corresponding thereto. The decision tree clustering method is assumed to be the same as that in the first embodiment, and therefore explanation thereof will be omitted.

The phoneme model clustering apparatus 2400 according to the third embodiment performs a process according to a flowchart shown in FIG. 19. However, in the phoneme model clustering apparatus 2400, the process at Step S1905 in FIG. 19 is different from that of the phoneme model clustering apparatus 100 according to the first embodiment.

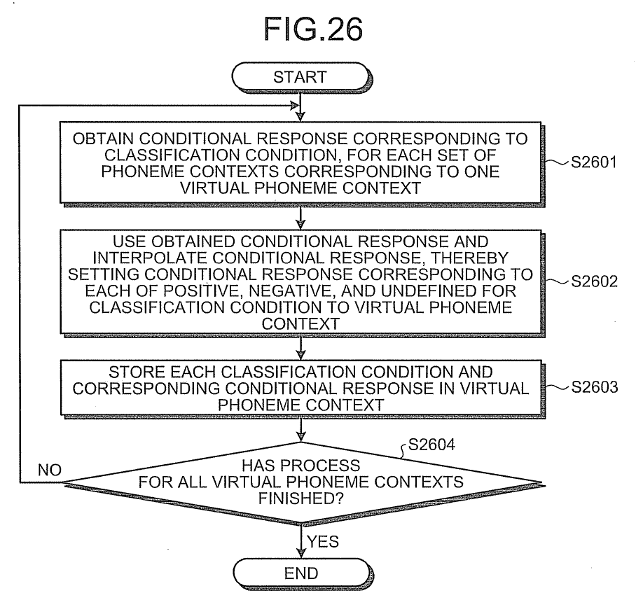

Therefore, a setting procedure of the conditional response corresponding to each classification condition at Step S1905 in FIG. 19 in the virtual-phoneme-model conditional-response setting unit 2411 according to the third embodiment is explained with reference to FIG. 26.

As for Steps S2601, S2603, and S2604 in FIG. 26, they are the same as Steps S2001, S2003, and S2004 in FIG. 20, and therefore explanations thereof will be omitted. Step S2602 executed by the virtual-phoneme-model conditional-response setting unit 2411 is explained below.

The virtual-phoneme-model conditional-response setting unit 2411 generates a new query set asking whether a response common to the virtual phoneme context is positive (Y), negative (N), or undefined (-) for each of the classification conditions relating to the response, and sets a conditional response corresponding to each of the newly generated queries (Step S2602).

With respect to the respective classification conditions stored in the phoneme-model classification-condition storage unit 101, the conditional response common to the virtual phoneme context is classified into three groups of positive (Y), negative (N), and undefined (-). In the phoneme model clustering apparatus 2400, however, by generating a new query asking whether the common response is positive (Y), negative (N), or undefined (-), the virtual context-dependent phoneme models can be classified into a group having positive (Y) as the common response and the other group, a group having negative (N) and the other group, and a group having undefined (-) and the other group.

By setting the classification condition set capable of classifying the virtual context-dependent phoneme models and the conditional response corresponding to the classification condition (query), the virtual context-dependent phoneme models can be classified in more detail, as compared with the first and second embodiments. Accordingly, clustering accuracy by the phoneme model clustering apparatus 2400 can be further improved.

In a fourth embodiment of the present invention, similarly to the second and third embodiments, a classification condition and a setting method of a conditional response different from the first embodiment are explained.

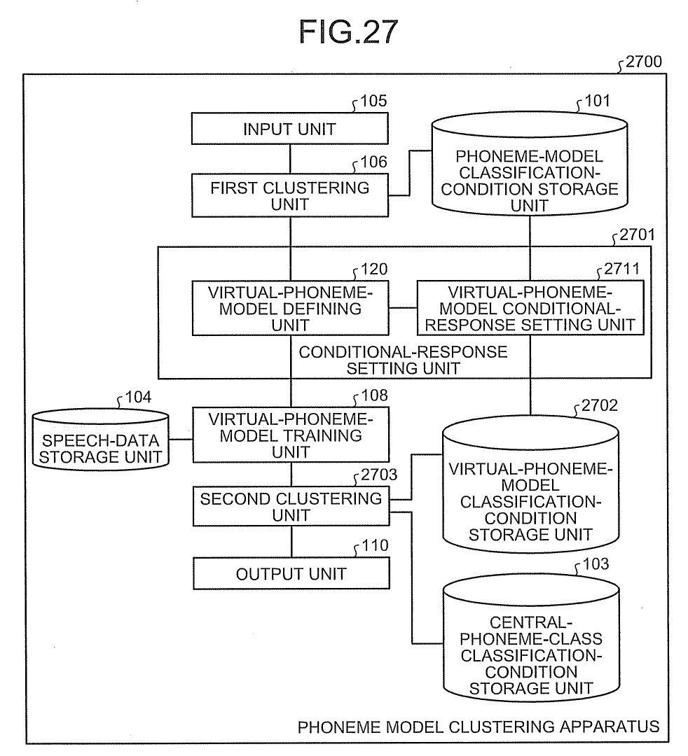

A phoneme model clustering apparatus 2700 shown in FIG. 27 is different from the phoneme model clustering apparatus 100 according to the first embodiment only in a feature that it includes a conditional-response setting unit 2701 that performs a process different from that of the conditional-response setting unit 107, a virtual-phoneme-model classification-condition storage unit 2702 having a data structure different from that of the virtual-phoneme-model classification-condition storage unit 102, and a second clustering unit 2703 that performs a process different from that of the second clustering unit 109. Explanations of the configuration of the phoneme model clustering apparatus 2700 common to the explanations of the phoneme model clustering apparatus 100 according to the first embodiment will be omitted.

The conditional-response setting unit 2701 includes the virtual-phoneme-model defining unit 120 and a virtual-phoneme-model conditional-response setting unit 2711.

The virtual-phoneme-model conditional-response setting unit 2711 obtains a response history used in clustering performed by the first clustering unit 106. The response history is information including classification condition (query) relating to the phoneme context used in clustering performed by the first clustering unit 106 and history of the conditional responses of positive (Y) or negative (N) corresponding to the classification condition, and the classification condition (query) which has not been used by the first clustering unit 106 and a conditional response indicating undefined (-) expressing that it is unused with respect to the classification condition. The virtual-phoneme-model conditional-response setting unit 2711 sets the response history as a common response to the virtual phoneme contexts, and registers it in the virtual-phoneme-model classification-condition storage unit 2702.

For example, a virtual context-dependent phoneme model “a1+R1y” having the virtual phoneme context “*+R1y” defines a set (a1+b) of context-dependent phoneme models. The response history includes a history of conditional responses of the set with respect to the queries “R_Voiced?” and “R_Alveolar?” used in the process of generating the leaf node including the set (a1+b) of context-dependent phoneme models in the first decision tree clustering by the first clustering unit 106, shown in FIG. 5. Specifically, as the history of the conditional responses, positive (Y), which is a conditional response corresponding to the query “R_Voiced?”, and negative (N), which is a conditional response corresponding to the query “R_Alveolar?” are included. Further, the response history includes undefined (-) as a conditional response to an unused query “R_Plosive?”. The virtual-phoneme-model conditional-response setting unit 2711 obtains such a response history as a response history with respect to the virtual right phoneme context “*+R1y”.

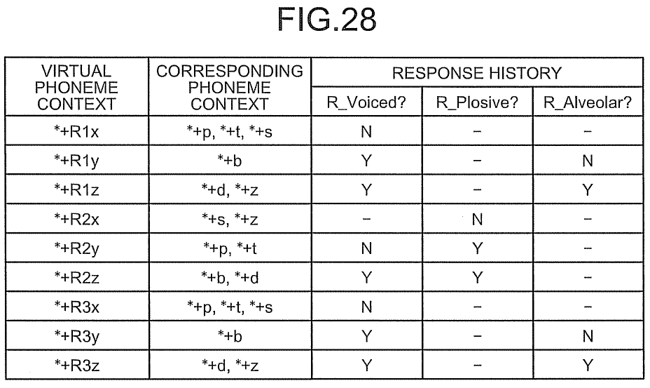

As shown in FIG. 28, the virtual-phoneme-model conditional-response setting unit 2711 sets a common response to the respective virtual phoneme contexts based on the response history obtained by the above process with respect to the set of virtual phoneme contexts shown in FIG. 5.

In an exemplary setting of the common response by the virtual-phoneme-model conditional-response setting unit 2711 shown in FIG. 28, as the common response to the virtual phoneme context “*+R1y”, positive (Y) is set as a common response corresponding to the query “R_Voiced?”, negative (N) is set as a common response corresponding to the query “R_Alveolar?”, and undefined (-) is set as a common response corresponding to the query “R_Plosive?”.

The virtual-phoneme-model classification-condition storage unit 2702 stores classification conditions generated by the virtual-phoneme-model conditional-response setting unit 2711 and common responses corresponding to the classification conditions (queries) as conditional responses for classification.

The second clustering unit 2703 executes decision tree clustering with respect to all the sets of virtual context-dependent phoneme models trained by the virtual-phoneme-model training unit 108, based on the query included in the central phoneme condition relating to the central phoneme class stored in the central-phoneme-class classification-condition storage unit 103 and a response corresponding thereto, and the query included in the classification condition set relating to the virtual phoneme context stored in the virtual-phoneme-model classification-condition storage unit 2702 and a conditional response corresponding thereto. The decision tree clustering method is assumed to be the same as that in the first embodiment, and therefore explanation thereof is omitted.

The phoneme model clustering apparatus 2700 according to the fourth embodiment performs a process according to a flowchart shown in FIG. 19. However, in the phoneme model clustering apparatus 2700, the process at Step S1905 in FIG. 19 is different from that of the phoneme model clustering apparatus 100 according to the first embodiment.

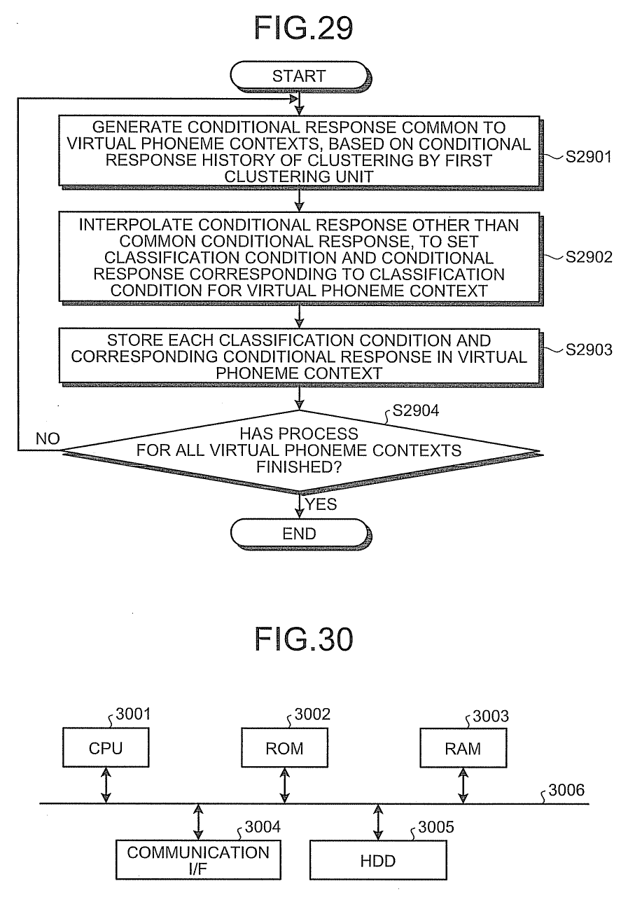

Therefore, a setting procedure of the conditional response corresponding to each classification condition at Step S1905 in FIG. 19 in the virtual-phoneme-model conditional-response setting unit 2711 according to the fourth embodiment is explained with reference to FIG. 29.

As for Steps S2902, S2903, and S2904 in FIG. 29, they are the same as Steps S2002, S2003, and S2004 in FIG. 20, and therefore explanations thereof will be omitted. Step S2901 executed by the virtual-phoneme-model conditional-response setting unit 2711 is explained below.

The virtual-phoneme-model conditional-response setting unit 2711 first obtains the response history of the decision tree clustering in the first clustering unit 106, to generate a response (conditional response) common to the virtual phoneme contexts based on the response history (Step S2901). The response history includes the classification condition used in the decision tree clustering by the first clustering unit 106, the conditional response corresponding to the classification condition, an unused classification condition, and “undefined” set as the conditional response corresponding to the unused classification condition.

The response history in the first decision tree clustering by the first clustering unit 106 used in the phoneme model clustering apparatus 2700 according to the fourth embodiment reflects which classification condition (query) is used and which conditional response is used with respect to the classification condition in the first decision tree clustering. That is, the virtual-phoneme-model classification-condition storage unit 2702 stores information indicating which classification condition (query) is used or unused. In the second decision tree clustering by the second clustering unit 2703, the clustering result of the first decision tree clustering and the process of the clustering can be reflected better. Accordingly, the second decision tree clustering accuracy by the second clustering unit 2703 can be further improved.

The fourth embodiment can be executed by combining the processes used in the second and third embodiments. Specifically, in the flowchart shown in FIG. 29, Step S2902 can be replaced by Step S2302 in the flowchart shown in FIG. 23 in the second embodiment to perform the process according to the flowchart shown in FIG. 29, thereby enabling to make a combination of the second and fourth embodiments.

Likewise, in the flowchart shown in FIG. 29, Step S2902 can be replaced by Step S2602 in the flowchart shown in FIG. 26 in the third embodiment to perform the process according to the flowchart shown in FIG. 29, thereby enabling to make a combination of the third and fourth embodiments.

As shown in FIG. 30, the phoneme model clustering apparatuses 100, 2100, 2400, and 2700 in the above embodiments include, as a hardware configuration, a read only memory (ROM) 3002 storing a phoneme-model clustering program for performing the above process, a central processing unit (CPU) 3001 that controls respective units in the phoneme model clustering apparatuses 100, 2100, 2400, and 2700 according to the program in the ROM 3002, a RAM 3003 as a data storage area, a communication interface (I/F) 3004 that connects to a network to perform communication, an HDD 3005 that is an external storage unit, and a bus 3006 that connects respective units to each other.

The phoneme-model clustering program can be recorded in a computer-readable recording medium such as a compact disk ROM (CD-ROM), a flexible disk (FD), or a digital versatile disk (DVD) in an installable format or executable format to be provided.

In this case, the phoneme-model clustering program is loaded on the RAM 3003 by being read from the above recording medium and executed in the phoneme model clustering apparatuses 100, 2100, 2400, and 2700, so that respective units explained in the software configuration above are generated on the RAM 3003.

Further, the phoneme model clustering program according to the above embodiments can be stored in a computer connected to a network such as the Internet, and downloaded through the network.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for clustering phoneme models, comprising:
an input unit configured to input a plurality of context-dependent phoneme models each including a phoneme context indicating a class of an adjacent phoneme and indicating a phoneme model having different acoustic characteristic of a central phoneme according to the phoneme context;
a first storage unit configured to store therein a classification condition of the phoneme context set according to the acoustic characteristic;
a first clustering unit configured to generate a cluster including the context-dependent phoneme models having a common central phoneme and common acoustic characteristic by performing a clustering for each of the context-dependent phoneme models having a common central phoneme according to the classification condition;
a first setting unit configured to set a conditional response indicating a response to each classification condition according to the acoustic characteristic with respect to each cluster according to the acoustic characteristic of the context-dependent phoneme model included in the cluster;
a second clustering unit configured to generate a set of clusters by performing a clustering with respect to a plurality of clusters according to the conditional response corresponding to the classification condition; and
an output unit configured to output the context-dependent phoneme models included in the set of clusters.

2. The apparatus according to claim 1, wherein
the first setting unit includes
a defining unit that defines a virtual context-dependent phoneme model having a virtual phoneme context that represents a set of phoneme contexts of the context-dependent phoneme models included in the cluster and representing a set of context-dependent phoneme models included in the cluster for each cluster, and
a second setting unit that sets a conditional response indicating a response corresponding to each classification condition according to the acoustic characteristic of the set of the phoneme contexts represented by the virtual phoneme context with respect to each of the virtual phoneme contexts, and
the second clustering unit generates a set of virtual context-dependent phoneme models by performing a clustering of the virtual context-dependent phoneme models according to the conditional response corresponding to the classification condition, and
the output unit outputs the set of context-dependent phoneme models defined by the virtual context-dependent phoneme models in units of set of the virtual context-dependent phoneme models.

3. The apparatus according to claim 2, further comprising:
a second storage unit configured to store therein a central phoneme classification condition indicating a classification condition relating to a class of the central phoneme of the virtual context-dependent phoneme models, wherein
the second clustering unit further performs a clustering of a plurality of virtual context-dependent phoneme models according to not only the conditional response corresponding to the classification condition but also the central phoneme classification condition.

4. The apparatus according to claim 3, further comprising:
a third storage unit configured to store therein speech data corresponding to the context-dependent phoneme model; and
a training unit configured to train the acoustic characteristic of the virtual context-dependent phoneme model based on the speech data corresponding to each set of context-dependent phoneme models defined as the virtual context-dependent phoneme model, wherein
the second clustering unit performs a clustering of the set of the virtual context-dependent phoneme models trained by the training unit.

5. The apparatus according to claim 2, wherein
the second setting unit sets a response corresponding to each of positives and negatives with respect to the classification condition for each classification condition as the conditional response according to the acoustic characteristic of each set of the phoneme contexts represented by the virtual phoneme contexts with respect to each of the virtual phoneme contexts.

6. The apparatus according to claim 2, wherein
the second setting unit sets a response corresponding to each of positives, negatives, and indefiniteness with respect to the classification condition for each classification condition as the conditional response according to the acoustic characteristic of each set of the phoneme contexts represented by the virtual phoneme contexts with respect to each of the virtual phoneme contexts.

7. The apparatus according to claim 3, wherein
the second setting unit sets the conditional response corresponding to each classification condition with respect to the virtual phoneme context based on a result of clustering the context-dependent phoneme models obtained by the first clustering unit.

8. A method of clustering phoneme models for a phoneme model clustering apparatus including a first storage unit that stores therein a classification condition of a phoneme context set according to acoustic characteristic, the method comprising:
inputting a plurality of context-dependent phoneme models each including the phoneme context and indicating a phoneme model having different acoustic characteristic of a central phoneme according to the phoneme context;
first clustering including
performing a clustering for each of the context-dependent phoneme models having a common central phoneme according to the classification condition, and
generating a cluster including the context-dependent phoneme models having a common central phoneme and common acoustic characteristic;
first setting including setting a conditional response indicating a response to each classification condition according to the acoustic characteristic with respect to each cluster according to the acoustic characteristic of the context-dependent phoneme model included in the cluster;
second clustering including
performing a clustering with respect to a plurality of clusters according to the conditional response corresponding to the classification condition, and
generating a set of clusters; and
outputting the context-dependent phoneme models included in the set of clusters.

9. The method according to claim 8, wherein
the first setting further includes
defining a virtual context-dependent phoneme model having a virtual phoneme context that represents a set of phoneme contexts of the context-dependent phoneme models included in the cluster and representing a set of context-dependent phoneme models included in the cluster for each cluster, and
second setting including setting a conditional response indicating a response corresponding to each classification condition according to the acoustic characteristic of the set of the phoneme contexts represented by the virtual phoneme context with respect to each of the virtual phoneme contexts, and
the second clustering further includes
performing a clustering of the virtual context-dependent phoneme models according to the conditional response corresponding to the classification condition, and
generating a set of virtual context-dependent phoneme models, and
the outputting includes outputting the set of context-dependent phoneme models defined by the virtual context-dependent phoneme models in units of set of the virtual context-dependent phoneme models.

10. The method according to claim 9, wherein
the phoneme model clustering apparatus further includes a second storage unit that stores therein a central phoneme classification condition indicating a classification condition relating to a class of the central phoneme of the virtual context-dependent phoneme models, and
the second clustering further includes performing a clustering of a plurality of virtual context-dependent phoneme models according to not only the conditional response corresponding to the classification condition but also the central phoneme classification condition.

11. The method according to claim 10, wherein
the phoneme model clustering apparatus further includes
a third storage unit that stores therein speech data corresponding to the context-dependent phoneme model, and
a training unit that trains the acoustic characteristic of the virtual context-dependent phoneme model based on the speech data corresponding to each set of context-dependent phoneme models defined as the virtual context-dependent phoneme model, and
the second clustering further includes performing a clustering of the set of the virtual context-dependent phoneme models trained by the training unit.

12. The method according to claim 9, wherein
the second setting further includes setting a response corresponding to each of positives and negatives with respect to the classification condition for each classification condition as the conditional response according to the acoustic characteristic of each set of the phoneme contexts represented by the virtual phoneme contexts with respect to each of the virtual phoneme contexts.

13. The method according to claim 9, wherein
the second setting further includes setting a response corresponding to each of positives, negatives, and indefiniteness with respect to the classification condition for each classification condition as the conditional response according to the acoustic characteristic of each set of the phoneme contexts represented by the virtual phoneme contexts with respect to each of the virtual phoneme contexts.

14. The method according to claim 10, wherein
the second setting further includes setting the conditional response corresponding to each classification condition with respect to the virtual phoneme context based on a result of clustering the context-dependent phoneme models obtained by the first clustering unit.

15. A computer-readable recording medium that stores therein a computer program for clustering phoneme models for a phoneme model clustering apparatus including a first storage unit that stores therein a classification condition of a phoneme context set according to acoustic characteristic, the computer program when executed causing a computer to execute:
inputting a plurality of context-dependent phoneme models each including the phoneme context and indicating a phoneme model having different acoustic characteristic of a central phoneme according to the phoneme context;
first clustering including
performing a clustering for each of the context-dependent phoneme models having a common central phoneme according to the classification condition, and
generating a cluster including the context-dependent phoneme models having a common central phoneme and common acoustic characteristic;
first setting including setting a conditional response indicating a response to each classification condition according to the acoustic characteristic with respect to each cluster according to the acoustic characteristic of the context-dependent phoneme model included in the cluster;
second clustering including
performing a clustering with respect to a plurality of clusters according to the conditional response corresponding to the classification condition, and
generating a set of clusters; and
outputting the context-dependent phoneme models included in the set of clusters.

16. The computer-readable recording medium according to claim 15, wherein
the first setting further includes
defining a virtual context-dependent phoneme model having a virtual phoneme context that represents a set of phoneme contexts of the context-dependent phoneme models included in the cluster and representing a set of context-dependent phoneme models included in the cluster for each cluster, and
second setting including setting a conditional response indicating a response corresponding to each classification condition according to the acoustic characteristic of the set of the phoneme contexts represented by the virtual phoneme context with respect to each of the virtual phoneme contexts, and
the second clustering further includes
performing a clustering of the virtual context-dependent phoneme models according to the conditional response corresponding to the classification condition, and
generating a set of virtual context-dependent phoneme models, and
the outputting includes outputting the set of context-dependent phoneme models defined by the virtual context-dependent phoneme models in units of set of the virtual context-dependent phoneme models.

17. The computer-readable recording medium according to claim 16, wherein
the phoneme model clustering apparatus further includes a second storage unit that stores therein a central phoneme classification condition indicating a classification condition relating to a class of the central phoneme of the virtual context-dependent phoneme models, and
the second clustering further includes performing a clustering of a plurality of virtual context-dependent phoneme models according to not only the conditional response corresponding to the classification condition but also the central phoneme classification condition.

18. The computer-readable recording medium according to claim 17, wherein
the phoneme model clustering apparatus further includes
a third storage unit that stores therein speech data corresponding to the context-dependent phoneme model, and
a training unit that trains the acoustic characteristic of the virtual context-dependent phoneme model based on the speech data corresponding to each set of context-dependent phoneme models defined as the virtual context-dependent phoneme model, and
the second clustering further includes performing a clustering of the set of the virtual context-dependent phoneme models trained by the training unit.

19. The computer-readable recording medium according to claim 16, wherein
the second setting further includes setting a response corresponding to each of positives and negatives with respect to the classification condition for each classification condition as the conditional response according to the acoustic characteristic of each set of the phoneme contexts represented by the virtual phoneme contexts with respect to each of the virtual phoneme contexts.

20. The computer-readable recording medium according to claim 16, wherein
the second setting further includes setting a response corresponding to each of positives, negatives, and indefiniteness with respect to the classification condition for each classification condition as the conditional response according to the acoustic characteristic of each set of the phoneme contexts represented by the virtual phoneme contexts with respect to each of the virtual phoneme contexts.
